(19) United States
(12) Patent Application Publication
(10) Pub. No.: US 2023/0280504 A1
(43) Pub. Date: Sep. 7, 2023

(54) SPECTACLE LENS WITH ANTIBACTERIAL AND/OR ANTIVIRAL PROPERTIES AND METHOD FOR MANUFACTURING THE SAME

(71) Applicant: Carl Zeiss Vision International GmbH, Aalen (DE)

(72) Inventors: Emad Flear Aziz, Aalen (DE); Liu Ouyang, Guangzhou (CN); Bernhard von Blanckenhagen, Aalen (DE)

(21) Appl. No.: 18/316,676

(22) Filed: May 12, 2023

Related U.S. Application Data
(63) Continuation of application No. PCT/EP2021/081558, filed on Nov. 12, 2021.

(30) Foreign Application Priority Data
Nov. 13, 2020 (WO) PCT/CN2020/128598

(51) Int. Cl. G02B 1/18; G02C 7/02; G02B 1/11; C03C 17/36; C03C 17/00

(52) U.S. Cl. CPC G02B 1/18; G02C 7/02; G02B 1/11; C03C 17/3644; C03C 17/007; C03C 2217/213; C03C 2217/212; C03C 2217/22; C03C 2217/256; C03C 2217/734; C03C 2218/151

(57) ABSTRACT

A spectacle lens having at least one antibacterial and/or antiviral coating and a method for manufacturing the same are disclosed. The spectacle lens includes (i) an anti-reflective coating or (ii) a mirror coating. The (i) anti-reflective coating or the (ii) mirror coating are made from a stack or a plurality of stack layers. The stack has an outermost stack layer containing silver (Ag). The outermost stack layer further contains a SiO₂-matrix having a plurality of separated silver (Ag) atoms and/or a plurality of silver (Ag) clusters. Each of the silver (Ag) clusters has a maximum expansion of less than 20 nm.

### CROSS REFERENCE TO RELATED APPLICATIONS

This application is a continuation application of International patent application PCT/EP2021/081558, filed on Nov. 12, 2021 and designating the U.S., which claims priority to International patent application PCT/CN2020/128598, filed on Nov. 13, 2020, both of which are hereby incorporated by reference in their entireties.

### TECHNICAL FIELD

The present disclosure relates to a spectacle lens comprising a coating comprising silver acting as an antibacterial and/or antiviral agent, as well as a method for manufacturing such a spectacle lens.

### BACKGROUND

As mentioned in S. Galdiero et al., “Silver Nanoparticles as Potential Antiviral Agents,” Molecules 2011, 16, 8894-8918, virus infections pose significant global health challenges, especially because of the emergence of resistant viral strains and the adverse side effects associated with prolonged use continue to slow down the application of effective antiviral therapies. Emerging and re-emerging viruses are to be considered a continuing threat to human health because of their ability to adapt to their current host, to switch to a new host and to evolve strategies to escape antiviral measures. Viruses can emerge because of the changes in the host, the environment, or the vector, and new pathogenic viruses can arise in humans from existing human viruses or from animal viruses. Viral diseases, such as the SARS coronavirus, the West Nile virus, the monkey pox virus, the Hantavirus, the Nipah virus, the Hendravirus, the Chikungunya virus, and the influenza viruses, recently of avian or swine origin, have affected human populations worldwide.

Organic antibacterial agents, photocatalytic materials and metallic compounds have been widely studied and their antibacterial and/or antiviral effect has been demonstrated.

U.S. Pat. No. 5,454,886 A assigned to Nucryst Pharmaceuticals Corp. discloses an anti-microbial coating, deposited as thin metallic film on at least one surface of a medical device by physical vapor deposition techniques under conditions which create atomic disorder in the anti-microbial coatings. According to U.S. Pat. No. 5,454,886 A, atomic disorder, including point defects in the crystal lattice, vacancies, line defects, interstitial atoms, amorphous regions, and grain or sub grain boundaries, when compared to normal ordered crystalline state found in bulk metal materials or alloys, is responsible for the sustained release of metal species, when in contact with an alcohol or a water-based electrolyte including a body fluid or body tissue. To create atomic disorder during the deposition process, the temperature of the surface to be coated may be maintained such that the ratio of the substrate temperature to the melting point of the metal in degrees Kelvin is less than about 0.5, for example. Atomic disorder may also be achieved by preparing composite metal materials, i.e., materials which contain at least one anti-microbial metal in a metal matrix which includes atoms or molecules different from the anti-microbial metals. As an anti-microbial metal silver may be used. For preparing the composite metal materials, at least one anti-microbial metal is co-deposited or sequentially deposited with at least one other inert, biocompatible metal or with an oxide, a nitride, a carbide, a boride, a sulfide, a hydride, or a halide of the at least one anti-microbial metal and/or the inert metal. The metals usable in the anti-microbial coatings should have an anti-microbial effect and should be biocompatible. Typically, the anti-microbial coatings have a film thickness of less than 1 μm and not greater than 10 μm.

WO 2019/082001 A1 assigned to Politecnico di Torino discloses an air filter comprising an air permeable substrate and an antiviral coating. The antiviral coating, having a thickness from 15 nm to 500 nm, comprises a first glass, ceramic, glass-ceramic material or matrix, typically silica, and a plurality of nanoclusters of a second metallic material, typically copper, zinc or silver. Further, WO 2019/082001 A1 discloses a method for the application of an antiviral coating to a substrate. This method comprises the co-deposition or co-sputtering process of at least a first glass, ceramic, glass-ceramic material or matrix, typically silica, and at least a plurality of nanoclusters of a second metallic material, typically silver, copper or zinc, on the substrate.

Miola et al. disclose in “Silver nanocluster-silica composite antibacterial coatings for materials to be used in mobile telephones,” Applied Surface Science 313 (2014) 107-115, the deposition of antibacterial coatings containing different amount of metallic silver nanoclusters embedded in a silica matrix by co-sputtering technique on several different polymers used in mobile telephones components such as: screens, covers, and microphone felts. Sputtering parameters have been varied to obtain different coating thickness and silver content, in order to meet antibacterial, aesthetic and functional requirements for each component.

Gladskikh et al. studied the optical properties of silver clusters in silica matrices. The conference paper “Optical Properties of Silver and Gold Clusters in Silica Matrices,” of the 2017 Nanocon held Oct. 18th-20th 2017, in Brno, Czech Republic, EU, describes on pages 821 to 825 the experimental studies of absorption and luminescence properties of silver nanoclusters embedded in silica matrixes. For this purpose, the authors produced thin SiO₂ films with different amount of silver by co-deposition of metal and SiO₂ onto the silica substrates in vacuum. Films with silver content possess three peaks in absorption spectra in near the UV range and two peaks in luminescence spectra in the visible range. Gladskikh et al. ascribed these spectral features to silver nanoclusters of different sizes being present in the film. The luminescence was observed only in the samples with the silver content of less than 2.2%. Quenching of the luminescence in the films with larger silver content were associated with the nonradiative energy transfer between close-packed particles. Thermal annealing leads to the formation of lager particles and transforms both absorption and emission spectra of the films.

GB2372044 B2 assigned to Samsung SDI Co. Ltd. discloses a functional film arrangement comprising a substrate and a transition layer deposited on the substrate, the transition layer comprising: a first constituent being at least one dielectric material such as SiOₓ where x>1; and a second constituent being silver, for example. The first and second constituents have gradual content gradients varying in a thickness direction of the film, a content of the first constituent being greatest at a face of the transition layer closest to the substrate.

JP 2020142494 A2 assigned to Ito Optical Ind. describes an antimicrobial transparent laminate comprising a single layer or multi-layer optical inorganic vapor-deposited film on at least one side of a transparent base material, in which the optical inorganic vapor-deposited film has a conforming film design including silica (SiO₂) as a final layer. The final layer of the vapor-deposited film is formed with a composite layer comprising an antimicrobial vapor-deposited layer containing a metal-loaded inorganic antimicrobial agent in which SiO₂ is serving as a matrix and a protective SiO₂ layer that adjoins to the outer side thereof. The metal-loaded inorganic antimicrobial agent may e.g., comprise Ag⁺-ions. A spectacle lens may be formed from the antimicrobial transparent laminate.

CN 106772713 A assigned to Shanghai Conant Optics Co. Ltd. discloses a spectacle lens comprising an antimicrobial coating layer. The coating of the lens substrate comprises the following layer sequence, beginning from the surface of the lens substrate: a hard coat layer, an antireflective layer comprising two to seven layers, an antibacterial layer, a binding layer, and a top layer. According to CN 106772713 A the binding layer should increase the adhesion between the antibacterial layer and the top layer. The antimicrobial layer may be silver, copper, zinc, titanium, or one or more metal oxide coated on the antireflection film. The adhesive layer may be made of silicon dioxide, silicon oxide, aluminum oxide, zirconium oxide of one or more oxides at the surface of the antibacterial layer.

U.S. Pat. No. 10,221,093 B2 assigned to Saint Gobain S. A. describes a (typically transparent glazing) substrate such as a window glass comprising a thin-film multilayer coated on one its faces. The thin-film multilayer comprises at least one metal functional film based on silver or made of silver having a thickness of between 7 nm and 20 nm and two antireflection coatings. The antireflection coatings each comprising at least one antireflection film. The metal functional film being placed between the two antireflection coatings. The multilayer comprises two discontinuous metal films each having a thickness of between 0.5 nm and 5 nm. A lower discontinuous metal film being located between the face and the only or first metal functional film as counted starting from the face and an upper discontinuous metal film being located above the only or last metal functional film as counted starting from the face. The lower discontinuous metal film and the upper discontinuous metal film are each based on silver or made of silver. The lower discontinuous metal film and the upper discontinuous metal film are each a discontinuous layer having a surface area occupation factor in the range of 50 percent to 98 percent and in the form of interconnected islands with uncovered regions between the islands.

From US 2020/209436 A1 assigned Fuji Holdings Corp. an antireflection film is known that is provided on a transparent substrate, such as a lens. The antireflection film comprises an interlayer, a silver-containing metal layer containing silver, and a dielectric layer. The interlayer, the silver-containing metal layer, and the dielectric layer are laminated in this order on a side of the substrate. The interlayer is a multilayer film having at least two layers in which a layer of high refractive index having a relatively high refractive index and a layer of low refractive index having a relatively low refractive index are alternately laminated. The dielectric layer has a surface exposed to air, and the dielectric layer is a multilayer film including a silicon-containing oxide layer, a magnesium fluoride layer, and an adhesion layer provided between the silicon-containing oxide layer and the magnesium fluoride layer and configures to increase adhesiveness between the silicon-containing oxide layer and the magnesium fluoride layer. The adhesion layer being provided separately from the silicon-containing oxide layer and the magnesium fluoride layer and being made of a metal oxide.

U.S. Pat. No. 10,527,760 B2 assigned to Essilor describes an ophthalmic lens comprising a transparent substrate being e.g., part of a liquid crystal display device of a portable telephone device with a front main face and with a rear main face, at least one of the main faces being coated with a multilayered antireflective coating comprising a stack composed of at least:
(i) a wetting layer;
(ii) a metal layer, wherein the metal is selected from silver, gold or copper or mixtures thereof;
(iii) a protective layer, which is able to avoid oxidation of the metal layer.

The wetting layer (i) is in direct contact with the metal layer (ii). The metal layer (ii) has a physical thickness ranging from 6 nm to 20 nm, and the multilayered antireflective coating has a total thickness ranging from 50 nm to 150 nm.

US 2015/0044482 A1 assigned to Don Co. Ltd. describes an optical coating structure, comprising:
(i) a substrate;
(ii) an anti-reflective coating layer disposed on the substrate, the anti-reflective coating layer covering the substrate;
(iii) a base coating layer covering the anti-reflective coating layer;
(iv) an antibacterial coating layer disposed on the base coating layer, the antibacterial coating layer being an interlayer; a protective coating layer covering the antibacterial coating layer.

Optionally, a super-hydrophobic coating layer and/or an anti-fingerprint coating layer may be disposed on the protective coating layer. Exemplarily, the substrate is described to include a transparent polymer resin, a tempered or a semi-tempered glass. The substrate may include a chemically tempered glass. Also, the substrate may be disposed on a display apparatus having a touch screen panel. The antibacterial coating layer may be formed by means of a vacuum vapor deposition process. The antibacterial coating layer may include silver (Ag) based materials, or the like. The antibacterial coating layer may include silver ion. The silver ion may be formed on the base coating layer including silicon dioxide. The silver ion may be combined with a small opening of the silicon dioxide surface. The protective coating layer may be disposed on the antibacterial coating layer and may entirely or partially cover the antibacterial coating layer. The protective coating layer may be formed on the antibacterial coating layer by a vacuum vapor deposition. The protective coating layer may include silicon dioxide-based materials.

CN 210534467 U assigned to Xiamen DuocaiI Optical Tech. Co. Ltd. discloses a seawater corrosion-proof antibacterial spectacle lens comprising a substrate, the substrate being coated on the front surface thereof with a hard coating, an antireflection coating, an anti-seawater coating and a waterproof coating. On the back surface, the substrate is coated with a hard coating, an adhesion coating, an antibacterial coating and a waterproof coating. The antibacterial coating is a silver film. The adhesion coating between the hard coating and the antibacterial coating can enhance the adhesion of the antibacterial coating.

WO 2020/138469 A1 assigned to Hoya Corp. discloses a spectacle lens in which high antimicrobial performance and antistatic performance are achieved simultaneously by the same outermost coating of the spectacle lens. The outermost coating contains tungsten oxide particles, tin oxide particles, and silver particles and a binder component such as silicon oxide. The binder component should improve the adhesion of the outermost coating. Typically, the thickness of the outermost coating is in the range of 3 nm to 30 nm. Further typically, the particle size of the tungsten oxide particles, the tin oxide particles and the silver particles is smaller than the thickness of the outermost coating to avoid the formation of protrusions on the outermost surface thereof. The particle size of the tungsten oxide particles, the tin oxide particles and the silver particles is typically from 2 nm to 5 nm. For obtaining a good antibacterial performance, the outermost coating comprises the tungsten oxide particles typically in a range of 0.25 to 0.80 wt.-%. For obtaining a good antistatic performance, the outermost coating comprises the tin oxide particles typically in a range of 0.10 to 0.35 wt.-%. For improving the antibacterial performance, the outermost coating comprises the silver particles typically in a range of 0.025 to 0.10 wt.-%. The outermost coating can be formed by dip coating. Due to the low thickness of the outermost coating, the optical characteristics of an existing coating design should not be deteriorated.

KR 200375582 Y1 of Yang Won Dong discloses glasses or sunglasses, wherein the material of sunglasses made of metal, glass or plastic resin contains nanosilver.

International patent application PCT/CN2020/104011, on which the disclosure is based, discloses a spectacle lens comprising a substrate and a sequence of layers deposited on both surfaces, namely front surface and back surface, of the substrate. The back surface of the substrate is covered with a hard coating layer, an adhesion layer, an anti-reflection (AR)-coating stack and optionally an outermost topcoat-layer functionally constituting a clean coating layer. The front surface of the substrate is covered with the same sequence of layers except of the outermost layer of the AR-coating stack which does not consist of SiO₂, only, but comprises Ag, in addition.

The difficulty in designing such lenses consists in fulfilling spectacles wearer's needs with respect to optical properties as well as health related properties.

### SUMMARY

It is therefore an object of the present disclosure to provide a spectacle lens being effective against remaining and spreading of bacteria and/or viruses on at least one of the spectacle lens surfaces, especially on the front surface and/or on the back surface of the spectacle lens, thereby avoiding the addition of a further coating into an existing coating stack or an existing coating design. A further objective is to provide an efficient method of manufacturing a spectacle lens being effective against the remaining and spreading of bacteria and/or viruses on at least one of the spectacle lens surfaces, especially of the front surface and/or on the back surface of the spectacle lens.

This objective is achieved by a spectacle lens having silver in an outermost layer of a layer stack, and a method for producing such a spectacle lens.

Typical exemplary embodiments, which might be realized in an isolated fashion or in any arbitrary combination, are discussed below.

The following definitions are used within the scope of the present description:

Spectacle Lens Substrate

The term “spectacle lens substrate” means in the context of the present disclosure any uncoated or precoated spectacle lens blank.

In particular, as spectacle lens substrate an uncoated or precoated blank, the blank being defined in section 3.8.1 of DIN EN ISO 13666:2019-12 as piece of optical material with one optically finished surface for the making of a lens; an uncoated or precoated single-vision blank, the single-vision blank being defined in section 3.8.2 of DIN EN ISO 13666:2019-12 as blank with the finished surface having a single nominal surface power; an uncoated or precoated multifocal blank, the multifocal blank being defined in section 3.8.3 of DIN EN ISO 13666:2019-12 as blank with the finished surface having two or more visibly divided portions of different dioptric powers or focal powers; an uncoated or precoated progressive-power blank, the progressive-power blank being defined in section 3.8.5 of DIN EN ISO 13666:2019-12 as power-variation blank where the finished surface is a progressive-power surface; an uncoated or precoated degressive-power blank, the degressive-power blank being defined in section 3.8.6 of DIN EN ISO 13666:2019-12 as power-variation blank where the finished surface is a degressive-power surface; an uncoated or precoated finished lens, the finished lens being defined in section 3.8.7 of DIN EN ISO 13666:2019-12 as lens of which both sides have their final optical surface; an uncoated or precoated uncut lens, the uncut lens being defined in section 3.8.8 of DIN EN ISO 13666:2019-12 as finished lens prior to edging; or an uncoated or precoated edged lens, the edged lens being defined in section 3.8.9 of DIN EN ISO 13666:2019-12 as finished lens edged to final size and shape may be used. If one of the before mentioned blanks is precoated, the respective finished surface comprises at least one coating. If one of the before mentioned lenses is precoated, at least one side thereof comprises at least one coating.

Typically, the spectacle lens substrate is an uncoated or precoated finished lens or an uncoated or precoated uncut lens.

The uncoated or precoated spectacle lens substrate may be classified as an afocal lens with nominally zero dioptric power according to section 3.6.3 of DIN EN ISO 13666:2019-12 or as corrective lens, i.e., as a lens with dioptric power according to section 3.5.3 of DIN EN ISO 13666:2019-12. Further, the uncoated or precoated spectacle lens substrate may be classified as single-vision lens according to section 3.7.1 of DIN EN ISO 13666:2019-12; as position-specific single-vision lens according to section 3.7.2 of DIN EN ISO 13666:2019-12; as multifocal lens according to section 3.7.3 of DIN EN ISO 13666:2019-12; as bifocal lens according to section 3.7.4 of DIN EN ISO 13666:2019-12; as trifocal lens according to section 3.7.5 of DIN EN ISO 13666:2019-12; as fused multifocal lens according to section 3.7.6 of DIN EN ISO 13666:2019-12; as power-variation lens according to section 3.7.7 of DIN EN ISO 13666:2019-12; as progressive-power lens according to section 3.7.8 of DIN EN ISO 13666:2019-12; or as degressive-power lens according to section 3.7.9 of DIN EN ISO 13666:2019-12.

Further, the uncoated or precoated spectacle lens substrate may be classified as protective lens according to section 3.5.4 of DIN EN ISO 13666:2019-12; as absorptive lens according to section 3.5.5 of DIN EN ISO 13666:2019-12; as tinted lens according to section 3.5.6 of DIN EN ISO 13666:2019-12; as clear lens according to section 3.5.7 of DIN EN ISO 13666:2019 12; as uniformly tinted lens according to section 3.5.8 of DIN EN ISO 13666:2019-12; a gradient-tinted lens according to section 3.5.9 of DIN EN ISO 13666:2019-12; as double gradient-tinted lens according to section 3.5.10; as photochromic lens according to section 3.5.11 of DIN EN ISO 13666:2019-12; or as polarizing lens according to section 3.5.12 of DIN EN ISO 13666:2019-12.

The uncoated or precoated spectacle lens substrate is typically based on an optical material, the optical material being defined according to section 3.3.1 of DIN EN ISO 13666:2019-12 as transparent material capable of being manufactured into optical components. The uncoated or precoated spectacle lens substrate may be made of mineral glass according to section 3.3.1 of DIN EN ISO 13666:2019-12 and/or of an organic hard resin such as a thermosetting hard resin according to section 3.3.3 of DIN EN ISO 13666:2019-12; a thermoplastic hard resin according to section 3.3.4 of DIN EN ISO 13666:2019-12; or a photochromic material according to section 3.3.5 of DIN EN ISO 13666:2019-12.

Typically, the uncoated or precoated spectacle lens substrate is based on one of the optical materials mentioned in table 1, particularly typical on one of the organic hard resins.

TABLE 1
Examples of optical materials for blanks or lenses

| | | Average | Abbe |
|---|---|---|---|
| | | refractive | number |
| Trade name | Optical material | index n_{D}* | v_{D}* |
| CR-39, CR-330, CR-607, CR-630, | Polyallyldiglycol | 1.500 | 56 |
| RAV 700, RAV 7NG, RAV 7AT, | carbonate ((P)ADC) | | |
| RAV 710, RAV 713, RAV 720 | | | |
| RA Volution | Polyurea/Polyurethane | 1.500 | 54 |
| Trivex | Polyurea/Polyurethane | 1.530 | 45 |
| Panlite, Lexan, Makrolon | Polycarbonate (PC) | 1.590 | 29 |
| MR-6 | Polythiourethane | 1.598 | |
| MR-8 | Polythiourethane | 1.598 | 41 |
| MR-7 | Polythiourethane | 1.664 | 32 |
| MR-10 | Polythiourethane | 1.666 | 32 |
| MR-174 | Polyepisulfide | 1.738 | 32 |
| MGC 1.76 | Polyepisulfide | 1.76 | 30 |
| Spectralite | Urethane/Methacrylate | 1.54 | |
| | Mineral 1.5 | 1.525 | 58 |
| | Mineral 1.6 | 1.604 | 44 |
| | Mineral 1.7 | 1.701 | 39, 2 |
| | Mineral 1.8 | 1.802 | 34, 4 |
| | Mineral 1.9 | 1.885 | 30 |

*Based on sodium D line

In case the uncoated or precoated spectacle lens substrate is made of mineral glass and of an organic hard resin such as a thermosetting hard resin or a thermoplastic hard resin, the mineral glass typically comprises at least one ultrathin lens. In this case, the organic hard resin may comprise an uncoated or precoated blank, an uncoated or precoated single-vision blank, an uncoated or precoated multifocal blank, an uncoated or precoated power-variation blank, an uncoated or precoated progressive-power blank, an uncoated or precoated degressive-power blank, an uncoated or precoated finished lens, an uncoated or precoated uncut lens; or an uncoated or precoated edged lens, each blank comprising on at least the finished surface thereof at least one ultrathin lens and each finished lens comprising on at least one side thereof at least one ultrathin lens.

After surfacing the opposite surface of the respective blank, this opposite surface may comprise at least one ultrathin lens as well, the at least one ultrathin lens being identical or different to the other one in relation to the glass composition, to the average thickness and/or to the shape. Further, the spectacle lens substrate may be made of at least two ultrathin lenses comprising a plastic film in-between. The at least one ultrathin lens may be based on various glass compositions, for example, be borosilicate glass, aluminum borosilicate glass or alkali-free borosilicate glass. Typically, the at least one ultrathin lens is based on a borosilicate glass or an aluminum borosilicate glass. The at least one ultrathin lens typically has an average thickness in a range from 10 μm to 1000 μm, further typically from a range from 13 μm to 760 μm, further typically from a range from 16 μm to 510 μm, more typically from a range from 18 μm to 390 μm and most typically from a range from 19 μm to 230 μm. Especially typically, the at least one ultrathin lens has an average thickness in a range from 21 μm to 121 μm or from 75 μm to 140 μm or from 80 μm to 220 μm. The average thickness of the at least one ultrathin lens is understood to mean the arithmetic average. Below an average thickness of 10 μm, the at least one ultrathin lens is too mechanically unstable to be able to be combined with at least one of the surfaces of at least one of the organic hard resin components mentioned before. Above an average thickness of 1000 μm, the at least one ultrathin lens can lead to spectacle lenses that would have too great an edge thickness or too great a middle thickness of the spectacle lens. The average thickness of the at least one ultrathin lens is measured typically with the Filmetrics F10-HC instrument from Filmetrics Inc. The at least one ultrathin lens typically has a surface roughness Ra of <1 nm. Further typically, the surface roughness Ra of the at least one ultrathin lens is within a range from 0.1 nm to 0.8 nm, more typically within a range from 0.3 nm to 0.7 nm and most typically within a range from 0.4 nm to 0.6 nm. The aforementioned values for surface roughness Ra are each based on the front surface and the back surface of the at least one ultrathin lens of an unformed, planar ultrathin lens. After forming, the aforementioned values are in each case applicable typically to that surface of the ultrathin lens that has not been brought into contact with the shaped body. Depending on the shaped body used for forming, the aforementioned values may also be applicable to the surface of the at least one ultrathin lens that was in contact with the shaped body used for forming. The surface roughness Ra of the at least one ultrathin lens is typically determined by means of white light interferometry, typically with the NewView 7100 instrument from Zygo Corporation. Ultrathin lenses are commercially available, for example, under the names: D 263 T eco, D 263 LA eco, D 263 M, AF 32 eco, SCHOTT AS 87 eco, B 270 I, each from Schott AG, or Corning Willow Glass or Corning Gorilla Glass, each from Corning Inc.

Top Coating

In the context of the present disclosure the term “top coating” means the outermost functional coating applied to a spectacle lens substrate in its final state.

Functional coating designates any coating having at least one of the properties being defined in the following:

Hard Coating

According to Sec. 3.18.2 of ISO 13666:2019 a hard coating is a coating on the surface of an organic lens (3.5.2) intended to enhance the abrasion resistance of the surface during normal use.

The term “hard coating” or “scratch resistant coating” or “abrasion resistant coating” in the context of the present disclosure denotes any coating being applied to a spectacle lens substrate increasing the abrasion resistance as compared to the uncoated spectacle lens substrate by a factor of at least 2 according to the Bayer test. The Bayer test is one of the most often cited test methods for abrasion resistance. This test subjects both a coated spectacle lens substrate and an uncoated CR-39 standard to abrasion from oscillating “sand.” The sand is actually alumina zirconia. After a set number of cycles, the haze gain is measured on both lenses. The ratio of haze gain of the uncoated lens to the coated lens is the Bayer Ratio. A Bayer Ratio of “1” means that the coating has equivalent abrasion resistance to uncoated CR-39. A Bayer Ratio of “5” means that the uncoated CR-39 standard had five times the haze gain as the coated lens. A common standard Bayer Ratio equal to “4” or greater is considered by the industry to be a premium hard coating.

In case the spectacle lens substrate is made of an organic hard resin, typically at least one of the finished surfaces of the spectacle lens substrate comprises at least one hard coating, further typically both finished surfaces of the spectacle lens substrate comprise at least one hard coating. The at least one finished surface of the spectacle lens substrate may be uncoated or precoated. The at least one hard coating typically has an average thickness in a range of from 0.6 μm to 10 μm, further typically in a range of from 0.8 μm to 6.6 μm, more typically in a range of from 1.1 μm to 5.8 μm and most typically in a range of from 1.6 μm to 4.9 μm. The average thickness of the at least one hard coating is typically determined by the measurement of the spectral reflectivity and/or the spectral transmissivity. The average thickness is the arithmetic average of the physical thickness of the at least one hard coating measured in at least three positions of the at least one hard coating after application and curing. Typically, an optical spectrometer, such as one of the devices F20, F10-HC or F10-AR of the company Filmetrics Inc., typically the device F10-HC, is used to determine the average thickness of the at least one hard coating. Illumination of a spectacle lens comprising a spectacle lens substrate and at least one hard coating with white light causes interference spectra dependent on the physical thickness of the at least one hard coating and the respective refractive index thereof. The path difference corresponds exactly to the multiple of the optical thickness. The average thickness is typically calculated with Fast Fourier Transformation (FFT). Alternatively, the average thickness of the at least one hard coating may be determined with at least one scanning electron microscope photograph of a cross-section of the spectacle lens comprising a spectacle lens substrate and at least one hard coating. The thickness of the at least one hard coating is determined in at least three positions and the arithmetic average is formed thereof.

The at least one hard coating may be based on at least one of the hard coating compositions disclosed in US 2005/0171231 A1, in US 2009/0189303 A1 or in US 2002/0111390 A1.

The at least one hard coating typically is based on at least one hard coating composition disclosed in EP 2 578 649 A1, particularly in EP 2 578 649 A1, claim 1. The at least one hard coating composition configured to produce the at least one hard coating typically comprises A) a) at least one silane derivative of the formula (I) Si(OR¹)(OR²)(OR³)(OR⁴), wherein R¹, R², R³, and R⁴, which may be the same or different, are selected from an alkyl, an acyl, an alkyleneacyl, a cycloalkyl, an aryl or an alkylenearyl group, each of which may optionally be substituted, and/or
b) at least one hydrolysis product of the at least one silane derivative of the formula (I), and/or
c) at least one condensation product of the at least one silane derivative of the formula (I), and/or
d) any mixture of the components a) to c) thereof;
B) a) at least one silane derivative of the formula (II) R⁶R⁷₃₋ₙSi(OR⁵)ₙ, in which R⁵ is selected from an alkyl, an acyl, an alkyleneacyl, a cycloalkyl, an aryl or an alkylenearyl group, each of which may optionally be substituted, R⁶ is an organic radical containing at least one epoxide group, R⁷ is selected from an alkyl, a cycloalkyl, an aryl or an alkylenearyl group, each of which may optionally be substituted, n is 2 or 3; and/or
b) at least one hydrolysis product of the at least one silane derivative of the formula (II), and/or
c) at least one condensation product of the at least one silane derivative of the formula (II), and/or any mixture of the components a) to c) thereof;
C) at least one colloidal inorganic oxide, hydroxide, oxide hydrate, fluoride and/or oxyfluoride;
D) at least one epoxide compound having at least two epoxide groups; and
E) at least one catalyst system comprising at least one Lewis acid and at least one thermolatent Lewis acid-base adduct.

The term “at least one hydrolysis product” of the at least one silane derivative of the formula (I) or (II) respectively expresses the fact that the at least one silane derivative of the formula (I) or of the formula (II) each has already been at least partly hydrolyzed to form silanol groups.

The term “at least one condensation product” of the at least one silane derivative of the formula (I) or of the formula (II) respectively expresses the fact that a certain degree of crosslinking has also already taken place through condensation reaction of the silanol groups.

The at least one silane derivative of the formula (I) may be selected from tetramethoxysilane, tetraethoxysilane, tetrapropoxysilane, tetraisopropoxysilane, tetrabutoxysilane, tetraisobutoxysilane, tetrakis(methoxyethoxy)silane, tetrakis(methoxypropoxy)silane, tetrakis(ethoxyethoxy)silane, tetrakis(methoxyethoxy-ethoxy)silane, trimethoxyethoxysilane, dimethoxydiethoxysilane or mixtures thereof.

The at least one silane derivative of the formula (II) may be selected from 3-glycidoxy-methyltrimethoxysilane, 3-glycidoxypropyltrihydroxysilane, 3-glycidoxypropyldimethyl-hydroxysilane, 3-glycidoxypropyldimethylethoxysilane, 3-glycidoxypropylmethyl-diethoxysilane, 3-glycidoxypropyltrimethoxysilane, 3-glycidoxypropyltriethoxysilane, 3-glycidoxypropyldimethoxymethylsilane, 3-glycidoxypropyldiethoxymethylsilane, 2-(3,4-epoxycyclohexyl)ethyltrimethoxysilane or mixtures thereof.

The at least one colloidal inorganic oxide may be selected from silicon dioxide, titanium dioxide, zirconium dioxide, tin dioxide, antimony oxide, aluminum oxide or mixtures thereof.

The mean particle diameter of the at least one colloidal inorganic oxide, hydroxide, fluoride or oxyfluoride is typically selected such that the transparency of the at least one hard coating is not affected. Typically, the at least one colloidal inorganic oxide, hydroxide, oxide hydrate, fluoride and/or oxyfluoride has a mean particle diameter in the range of from 2 nm to 150 nm, even more typically of from 2 nm to 70 nm. The mean particle diameter is determined typically by means of dynamic light scattering. The at least one colloidal inorganic oxide, hydroxide, oxide hydrate, fluoride or oxyfluoride contributes to an increase in scratch resistance through incorporation into the existing network. In addition, selection of at least one colloidal inorganic oxide, hydroxide, oxide hydrate, fluoride or oxyfluoride allows the refractive index of the at least one hard coating to be matched to the refractive index of the uncoated spectacle lens substrate or to a precoating of the spectacle lens substrate.

The at least one epoxide compound having at least two epoxide groups is typically a polyglycidyl ether compound, more typically a diglycidyl ether or triglycidyl ether compound. For example, as at least one epoxide compound comprising at least two epoxide compounds digylcidyl ether, ethylenglycoldiglycidyl ether, propylenglycoldiglycolglycidyl ether, 1,4-butandioldiglycidyl ether, 1,6-hexandioldiglycidyl ether, trimethylolpropantriglycidyl ether, triglycidylglycerin and/or trimethylolethantriglycidylether may be used in the coating composition. Typically, the at least epoxide compound comprises trimethylolpropantriglycidyl ether, butandioldiglycidyl ether and/or 1,6-hexandioldiglycidyl ether.

The at least one catalyst system comprising at least one Lewis acid and at least one thermolatent Lewis acid-base adduct enables very homogeneous crosslinking and hence also constantly high strength over the entire layer thickness of the at least one hard coating. The term “Lewis acid” relates to an electrophilic electron pair acceptor compound, the term “Lewis base” is understood to mean an electron pair donor compound. The at least one Lewis acid is typically one which have catalytic activity even at relatively low temperatures, for example at room temperature. The at least one Lewis acid may be selected from ammonium salts, metal salts, especially of metals from one of groups 1 (i.e., alkali metal salts), 2 (i.e., alkaline earth metal salts) or 13 (typically Al or B) of the periodic table of the elements, halides of an element of group 13 of the periodic table of the elements (especially AIX₃ or BX₃, where X is chlorine or fluorine), organic sulphonic acids and amine salts thereof, alkali metal or alkaline earth metal salts, for example alkali metal or alkaline earth metal salts of carboxylic acids, fluoride salts, organotin compounds, or a mixture thereof. Typical metal salts of metals from one of the groups 1, 2 and 13 of the periodic table of the elements are, for example, perchlorates or carboxylates. Typical Lewis acids are, for example, ammonium perchlorate, magnesium perchlorate, sulphonic acids and salts thereof, such as trifluoromethanesulphonic acid and salts thereof.

The at least one Lewis acid-base adduct is understood to mean a compound which has catalytic activity with regard to the chemical reaction in question only at relatively high temperatures, while it is essentially still catalytically inactive at room temperature. Only through the supply of sufficient thermal energy is a thermolatent catalyst compound converted to a catalytically active state.

The at least one silane derivative of the formula (I) and/or the at least one hydrolysis product of the silane derivative of the formula (I) and/or the at least one condensation product of the silane derivative of the formula (I) is/are typically present in the at least one hard coating composition in an amount of 5% by weight to 50% by weight, more typically of 6% by weight to 20% by weight, each based on the total weight of the at least one hard coating composition. The amounts given before applying with regard to the at least one silane derivative of the formula (I), with regard to the at least one hydrolysis product of the formula (I), with regard to the at least one condensation product of the formula (I) or with regard to any mixture thereof. The amounts given before applying as well with regard to a mixture of silane derivatives of the formula (I), with regard to a mixture of hydrolysis products of the at least one silane derivative of the formula (I), with regard to a mixture of condensation products of the at least one silane derivative of the formula (I) or with regard to any mixture thereof.

The at least one silane derivative of the formula (II) and/or the at least one hydrolysis product of the silane derivative of the formula (II) and/or the at least one condensation product of the silane derivative of the formula (II) is/are typically present in the at least one hard coating composition in an amount of 5% by weight to 50% by weight, more typically of 6% by weight to 20% by weight, each based on the total weight of the at least one hard coating composition. The amounts given before applying with regard to the at least one silane derivative of the formula (II), with regard to the at least one hydrolysis product of the formula (II), with regard to the at least one condensation product of the formula (II) or with regard to any mixture thereof. The amounts given before applying as well with regard to a mixture of silane derivatives of the formula (II), with regard to a mixture of hydrolysis products of the at least one silane derivative of the formula (II), with regard to a mixture of condensation products of the at least one silane derivative of the formula (II) or with regard to any mixture thereof.

The weight ratio of the at least one silane derivative of the formula (I), the at least one hydrolysis product of the silane derivative of the formula (I) and/or the at least one condensation product of the silane derivative of the formula (I) relative to the at least one silane derivative of the silane derivative of the formula (II), the at least one hydrolysis product of the silane derivative of the formula (II) and/or the at least one condensation product of the silane derivative of the formula (II) is typically in the range of from 95/5 to 5/95, more typically in the range of from 70/30 to 30/70, and most typically in the range of from 60/40 to 40/60.

The at least one colloidal inorganic oxide, hydroxide, fluoride and/or oxyfluoride is/are present in the at least one hard coating composition typically in an amount of 5% by weight to 50% by weight, more typically of 6% by weight to 25% by weight, each based on the total weight of the at least one hard coating composition. The amounts mentioned before applying for one type of colloidal oxide, one type of hydroxide, one type of fluoride, one type of oxyfluoride, for a mixture thereof, for a mixture of different colloidal oxides, a mixture of different colloidal hydroxides, a mixture of different colloidal fluorides, a mixture of different colloidal oxyfluorides or for any mixture thereof. The mixture of different colloidal oxides, hydroxides, fluorides or oxyfluorides may for example comprise one type of each in different particle sizes or different types of each in the same or in a different particle size.

The at least one epoxide compound having at least two epoxide groups is present in the at least one hard coating composition typically in an amount of 0.1% by weight to 10% by weight, more typically of 0.5% by weight to 10% by weight, each based on the total weight of the at least one hard coating composition. The amounts given before applying with regard to one type of epoxide compound or to a mixture of different types of epoxide compounds.

The at least one catalyst system is present in the at least one hard coating composition typically in an amount in the range from 0.01% by weight to 5% by weight, more typically in the range from 0.1% by weight to 3% by weight, each based on the total weight of the hard coating composition.

The weight ratio of at least one Lewis acid to the at least one thermolatent Lewis acid-base adduct is typically in the range from 20/1 to ½, more typically from 5/1 to 2/1.

The hard coating composition further comprises at least one solvent comprising at least one alcohol, at least one ether, at least one ester or water. In case the at least one solvent comprises two different solvents, the boiling point of the first solvent Si and the boiling point of the second solvent S2 is either S1/S2≥1.2 or S1/S2≤0.8. Further, in case the at least one solvent comprises two different solvents, the weight ratio of the first solvent to the second solvent is typically in the range of from 5 to 0.01, more typically in the range of from 2 to 0.2.

Typically water is present in an amount of 2% by weight to 15% by weight, based on the total weight of the hard coating composition.

The components of the coating composition resulting in a hard coating are used in that they add to 100% by weight based on the total weight of the coating composition.

The coating composition mentioned before resulting in at least one hard coating is typically applied to at least one of the uncoated or precoated surfaces of the spectacle lens substrate, typically on both surfaces of the spectacle lens substrate by dip coating or by spin coating.

The use of the above mentioned coating composition comprising the components (A) to (E), i.e., at least one first silane derivative of formula (I), at least one hydrolysis product and/or at least one condensation product thereof, at least one second silane derivative of formula (II), at least one hydrolysis product and/or at least one condensation product thereof, at least one colloidal inorganic oxide, hydroxide, fluoride and/or oxyfluoride, at least one epoxide compound and at least one catalyst system, enables the production of at least one hard coating having very good adhesive strength on at least one surface of different types of uncoated or precoated spectacle lens substrates, having a high hardness, being of high scratch resistance and showing a low tendency to crack formation on at least one surface of different types of uncoated or precoated spectacle lens substrates.

Alternatively, or additionally to the before mentioned at least one hard coating composition resulting in at least one hard coating, at least one of the finished surfaces of the uncoated or precoated spectacle lens substrate, typically both finished surfaces of the uncoated of precoated spectacle lens substrate, comprises at least one hard coating which is typically based on at least one hard coating composition comprising
A) a) at least one silane derivative of the formula (III) R¹R²₃₋ₙSi(OR³)ₙ, wherein R¹ comprises an alkyl group, a cyclo alkyl group, an acyl group, an aryl group or a hetero aryl group, each of which may be substituted, R² is an organic rest comprising an epoxide group, R³ comprises an alkyl group, a cyclo alkyl group, an aryl group or a hetero aryl group, each of which may be substituted, n=2 or 3, and/or
b) at least one hydrolysis product of the silane derivative of the formula (III), and/or
c) at least one condensation product of the silane derivative of the formula (III), and/or
d) any mixture of components a) to c);
B) at least one colloidal inorganic oxide, hydroxide, oxide hydrate, fluoride and/or oxyfluoride;
C) at least one epoxy component comprising at least two epoxy groups; and
D) at least one catalyst system comprising at least one Lewis acid and at least one thermolatent Lewis base-adduct.

The term “at least one hydrolysis product” of the at least one silane derivative of the formula (III) expresses the fact that the at least one silane derivative of the formula (III) has already been at least partly hydrolyzed to form silanol groups.

The term “at least one condensation product” of the at least one silane derivative of the formula (III) expresses the fact that a certain degree of crosslinking has also already taken place through condensation reaction of the silanol groups.

The at least one silane derivative of the formula (III) and/or the at least one hydrolysis product of the silane derivative of the formula (III) and/or the at least one condensation product of the at least one silane derivative of the formula (III) and/or any mixture thereof is/are present in the at least one hard coating composition in a total amount in the range typically of from 9% by weight to 81% by weight, further typically of from 13% by weight to 76% by weight, more typically of from 19% by weight and most typically of from 23% by weight to 66% by weight, each based on the total weight of the at least one coating composition. The amounts given before applying with regard to the at least one silane derivative of the formula (III), with regard to the at least one hydrolysis product of the formula (III), with regard to the at least one condensation of the formula (III) or with regard to any mixture thereof. The amounts given before applying as well with regard to a mixture of silane derivatives of the formula (III), with regard to a mixture of hydrolysis products of the at least one silane derivative of the formula (III), with regard to a mixture of condensation products of the at least one silane derivative of the formula (III) or with regard to any mixture thereof.

The at least one colloidal inorganic oxide, hydroxide, oxide hydrate, fluoride and/or oxyfluoride is/are present in the at least one hard coating composition in a total amount in the range typically of from 3% by weight to 60% by weight, further typically of from 6% by weight to 58% by weight, more typically of from 9% by weight to 57% by weight and most typically of from 13% by weight to 55% by weight, each based on the total weight of the at least one hard coating composition. The amounts given before applying with regard to one type of colloidal inorganic oxide, one type of colloidal inorganic hydroxide, one type of colloidal inorganic oxide hydrate, one type of colloidal inorganic fluoride, one type of colloidal inorganic oxyfluoride and any mixture thereof. The amounts given before applying as well with regard to a mixture of different colloidal inorganic oxides, a mixture of different colloidal inorganic hydroxides, a mixture of different colloidal inorganic oxide hydrates, a mixture of different colloidal inorganic fluorides, a mixture of different colloidal inorganic oxyfluorides or any mixture thereof. The mentioned mixtures may include each different particles sizes or different types of colloidal inorganic oxides, hydroxides, oxide hydrates, fluorides and/or oxyfluorides.

The at least one epoxide compound comprising at least two epoxide groups is present in the at least one hard coating composition in an amount in the range typically of from 0.01% by weight to 14% by weight, further typically of from 0.07% by weight to 11% by weight, more typically of from 0.1% by weight to 6% by weight and most typically of from 0.2% by weight to 13% by weight, each based on the total weight of the at least one hard coating composition. The amount given before applying with regard to one type of epoxide compound as well as with regard to a mixture of different epoxide compounds.

The at least one catalyst system comprising at least one Lewis acid and at least one thermolatent Lewis base-adduct is present in the at least one hard coating composition in an amount in the range typically from 0.04% by weight to 4% by weight, further typically from 0.1% by weight to 3% by weight, more typically from 0.2% by weight to 2% by weight and most typically from 0.3% by weight to 1% by weight, each based on the total weight of the at least one hard coating composition. The weight ratio of the at least one Lewis acid to the at least one thermolatent Lewis base-adduct is typically in a range from 20:1 to 2:1, further typically from 18:1 to 1:2, more typically from 13:1 to 1:1 and most typically from 6:1 to 1:1.

The at least one hard coating composition may comprise at least one organic solvent and/or water. The components of the at least one hard coating composition resulting in at least one hard coating are used in that they add to 100% by weight based on the total weight of the at least one hard coating composition.

As at least one silane derivate of the formula (III) 3-glycidoxymethyl-itrimethoxysilane, 3-glycidoxypropyltrihydroxysilane, 3-glycidoxypropyl-dimethylhydroxysilane, 3-glycidoxy-propyldimethylethoxysilane, 3-glycidoxypropylmethyldiethoxysilane, 3-glycidoxypropyl-trimethoxysilane, 3-glycidoxypropyl-itriethoxysilane, 3-glycidoxypropyl-dimethoxymethyl-isilane, 3-glycidoxypropyldiethoxymethylsilane and/or 2-(3,4-epoxycyclohexyl)ethyltrimethoxysilane, for example, may be used in the at least one hard coating composition. Typically, 3-glycidoxypropyltrimethoxysilane and/or 3-glycidoxy-propyltriethoxysilane is/are used as silane derivative of the formula (III).

The at least one colloidal inorganic oxide, hydroxide and/or oxide hydrate may be a metal oxide, metal hydroxide and/or metal oxide hydrate, where the metal ions of the metal oxide, metal hydroxide and/or metal oxide hydrate comprise or are metals of titanium, typically TiO₂, of silicon, typically SiO₂, of zirconium, typically ZrO₂, of tin, typically SnO₂, of antimony, typically Sb₂O₃, of aluminum, typically Al₂O₃ or AlO(OH) and/or mixed oxides and/or mixtures thereof. Typically, the colloidal inorganic oxide, hydroxide, oxide hydrate is a metal oxide, metal hydroxide and/or metal oxide hydrate, wherein the metal ions of the metal oxide, metal hydroxide and/or metal oxide hydrate comprise or are metals of titanium, silicon, zirconium or mixtures thereof, further typically of silicon. Further typically, the at least one colloidal inorganic oxide, hydroxide and/or oxide hydrate form core-shell particles. In such core-shell particles the core comprises typically a metal oxide, metal hydroxide and/or metal oxide hydrate, wherein the metal ions of the metal oxide, metal hydroxide and/or metal oxide hydrate comprise or are metals of titanium, typically TiO₂, and/or of zirconium, typically ZrO₂ and the shell comprises typically a metal oxide, metal hydroxide and/or metal oxide hydrate, wherein the metal ions of the metal oxide, metal hydroxide and/or metal oxide hydrate comprise or are silicon, typically SiO₂. As colloidal inorganic fluoride magnesium fluoride may be used. The at least one colloidal oxide, hydroxide, oxide hydrate, fluoride and/or oxyfluoride has a mean particle size in the range typically from 3 nm to 70 nm, further typically from 6 nm to 64 nm, more typically from 8 nm to 56 nm and most typically from 9 nm to 52 nm.

As at least one epoxide compound comprising at least two epoxide compounds digylcidyl ether, ethylenglycoldiglycidyl ether, propylenglycoldiglycolglycidyl ether, 1,4-butandioldiglycidyl ether, 1,6-hexandioldiglycidyl ether, trimethylolpropantriglycidyl ether, triglycidylglycerin and/or trimethylolethantriglycidylether for example may be used in the at least one hard coating composition. Typically, the at least epoxide compound comprises trimethylolpropantriglycidyl ether, butandioldiglycidyl ether and/or 1,6-hexandioldiglycidyl ether.

As at least one Lewis acid ammonium perchlorate, magnesium perchlorate, sulfonic acids and/or salts of sulfonic acids, such as trifluormethane sulfonic acid and/or salts thereof, for example may be used in the at least one catalyst system.

As at least one Lewis base-adduct a metal complex compound, such as aluminum acetylacetonate, iron acetylacetonate and/or zinc acetylacetonate, for example may be used in the at least one catalyst system.

The use of the at least one hard coating composition comprising the components (A) to (D), i.e., at least one silane derivative of the formula (III), at least one hydrolysis product and/or at least one condensation product thereof, least one colloidal inorganic oxide, hydroxide, oxide hydrate, fluoride and/or oxyfluoride, at least one epoxide compound and at least one catalyst system, enables the production of at least one hard coating having very good adhesive strength on at least one surface of different types of uncoated or precoated spectacle lens substrates, having a high hardness, being of high scratch resistance and showing a low tendency to crack formation on at least one surface of different types of uncoated or precoated spectacle lens substrates.

The at least one hard coating composition resulting in at least one hard coating is typically applied to at least one uncoated or precoated surface of the spectacle lens substrate, further typically to both surfaces thereof, by dip coating or by spin coating.

Adhesion Promoting Layer

The term “adhesion promoting layer” means any intermediate coating layer increasing the adhesion between a directly adjacent overlying coating layer and a directly adjacent underlying lower coating layer or a directly adjacent underlying spectacle lens substrate.

Primer Coating

The term “primer coating” applies to any coating being applied to a spectacle lens substrate increasing the impact resistance as compared to a hard-coated spectacle lens substrate (i.e., a spectacle lens substrate comprising a hard coating as described above) by a factor >1 according to the repetitive ball drop test according to ISO 16936-1:2020.

In case the spectacle lens substrate is made of an organic hard resin, typically at least one of the finished surfaces of the spectacle lens substrate is coated with at least one hard coating as described above and at least one primer coating. If the spectacle lens comprises at least one hard coating and at least one primer coating, the at least one primer coating is the coating that is located next, but not necessarily adjacent, to the at least one finished surface of the spectacle lens substrate to be coated. Phrased differently, if at least one of the finished surfaces of the spectacle lens substrate is coated with at least one primer coating and with at least one hard coating, typically the at least one hard coating is furthest away from the to be coated surface of the spectacle lens substrate. The at least one finished surface of the spectacle lens substrate may be uncoated or precoated. Further typically, both surfaces of the uncoated of precoated spectacle lens substrate comprise at least one primer coating.

The average thickness of the at least one primer coating typically lies in a range of from 300 nm to 1200 nm, further typically in a range of from 340 nm to 1150 nm, further typically in a range of from 390 nm to 1120 nm, more typically in a range of from 440 nm to 1110 nm and most typically in a range of from 470 nm to 1100 nm. The average thickness is the arithmetic average of the physical thickness of the at least one primer coating measured in at least three positions of the at least one primer coating after application and curing. Typically, the average thickness of the at least one primer coating is determined by the measurement of the spectral reflectivity and/or the spectral transmissivity. Typically, an optical spectrometer, such as one of the devices F20, F10-HC or F10-AR of the company Filmetrics Inc., typically the device F10-HC, is used to determine the average thickness of the at least one primer coating. Illumination of a spectacle lens comprising a spectacle lens substrate and at least one primer coating with white light causes interference spectra dependent on the physical thickness of the at least one primer coating and the respective refractive index thereof. The path difference corresponds exactly to the multiple of the optical thickness. The average thickness is typically calculated with Fast Fourier Transformation (FFT). Alternatively, the average thickness of the at least one primer coating may be determined with at least one scanning electron microscope photograph of a cross-section of the spectacle lens comprising a spectacle lens substrate and at least one primer coating. The thickness of the at least one primer coating is determined in at least three positions and the arithmetic average is formed thereof.

The at least one primer coating may typically be based on at least one primer coating composition comprising
i) at least one aqueous aliphatic, cycloaliphatic, aromatic or heteroaromatic polyurethane dispersion, at least one aqueous aliphatic, cycloaliphatic, aromatic or heteroaromatic polyurea dispersion, at least one aqueous aliphatic, cycloaliphatic, aromatic or heteroaromatic polyurethane-polyurea dispersion and/or at least one aqueous aliphatic, cycloaliphatic, aromatic or heteroaromatic polyester dispersion, typically at least one aqueous aliphatic polyurethane dispersion or at least one aqueous aliphatic polyester dispersion and more typically at least one aqueous aliphatic polyurethane dispersion,
ii) at least one solvent,
iii) optionally at least one additive.

The at least one aqueous aliphatic, cycloaliphatic, aromatic or heteroaromatic polyurethane dispersion, at least one aqueous aliphatic, cycloaliphatic, aromatic or heteroaromatic polyurea dispersion, at least one aqueous aliphatic, cycloaliphatic, aromatic or heteroaromatic polyurethane-polyurea dispersion and/or at least one aqueous aliphatic, cycloaliphatic, aromatic or heteroaromatic polyester dispersion is/are present in the at least one primer coating composition in a total amount selected from a range typically of from 2% by weight to 38% by weight, further typically of from 4% by weight to 34% by weight, further typically of from 5% by weight to 28% by weight, more typically of from 6% by weight to 25% by weight and most typically of from 7% by weight to 21% by weight, each based on the total weight of the at least one primer coating composition. The total amount comprises the amount of only one of the dispersions mentioned before or a mixture thereof.

The at least one primer coating composition comprises typically at least one aqueous polyurethane dispersion, wherein the polyurethane comprises a polyester unit as a spacer or the polyurethane dispersion is a polyurethane-polyurea dispersion, characterized by the occurrence of both urethane and urea groups in a macromolecular chain of the polyurethane-polyurea. Such polyurethane dispersions are described for example in WO 94/17116 A1, in particular in WO 94/17116 A1, page 7, lines 11 to 33. The aqueous polyurethane dispersion may be blended with anionically stabilized acrylic emulsions, as described in WO 94/17116 A1, in particular in WO 94/17116 A1, page 7, lines 33 to 35.

The at least one solvent is present in the at least one primer coating composition in an amount selected from a range typically of from 68% by weight to 99% by weight, further typically of from 69% by weight to 98% by weight, more typically of from 81% by weight to 97% by weight and most typically of from 89% by weight to 93% by weight, each based on the total weight of the at least one primer coating composition. The amounts mentioned before applying with regard to one type of solvent as well as with regard to a mixture of different solvents.

As at least one solvent typically at least one organic solvent with a low boiling point of <100° C. under normal pressure and at least one organic solvent with a middle boiling of 100° C. to 150° C. under normal pressure may be used. As at least one organic solvent with a low boiling point methanol, ethanol, 1-propanol, 2-propanol, tert-butanol, acetone, diethyl ether, tert-butylmethyl ether, tetrahydrofuran, chloroform, 1,2-dichlorethane, methylene chloride, cyclohexane, ethyl acetate, n-hexane, n-heptane and/or methyl ethyl ketone for example may be used. Typically, methanol, ethanol, 1-propanol and/or 2-propanol is/are used as at least one solvent with a low boiling point. As at least one organic solvent with a middle boiling point 1-methoxy-2-propanol, 1-butanol, dibutyl ether, 1,4-dioxan, 3-methyl-1-butanol, 4-hydroxy-4-methyl-2-pentanone, methylisobutylketone and/or toluol for example may be used. Typically, 1-methoxy-2-propanol and/or 4-hydroxy-4-methyl-2-pentanone is/are used as at least one solvent with a middle boiling point.

The weight ratio of the at least one solvent with a low boiling point to the at least one solvent with a middle boiling point is typically 1:1, further typically 1:1.4, more typically 1:1.5 and most typically 1:1.7.

As at least one solvent at least one organic solvent with a low boiling point, at least one solvent with a middle boiling point and water may be used. The weight ratio of the at least one solvent with a low boiling point to the at least one solvent with a middle boiling point to water is typically 2:7:1, further typically 2.5:6.5:1, further typically 3:6:1, more typically 3:5:1 and most typically 3:6:1.

The at least one primer coating composition may comprise optionally at least one additive. The at least one additive may comprise at least one dispersing agent, at least one anti-settling agent, at least one wetting agent, at least one biocide, at least one UV-absorber or mixtures thereof. The at least one additive may be present in the at least one primer coating composition typically in an amount from a range of from 0.01% by weight to 1.7% by weight, further typically in an amount from a range of from 0.07% by weight to 1.4% by weight, more typically in an amount from a range of from 0.09% by weight to 1.1% by weight and most typically in an amount from a range of from 0.1% by weight to 0.7% by weight, each based on the total weight of the at least one primer coating composition. The amounts mentioned before applying with regard to one type of additive as well as with regard to a mixture of different additives.

The at least one primer coating composition comprising the components i) to iii), i.e., the at least one dispersion, the at least one solvent and optionally the at least one additive, after application on at least one of the uncoated or precoated surfaces of the spectacle lens substrate, drying and curing results in at least one primer coating.

The at least one primer coating composition resulting in at least one primer coating is typically applied to at least one precoated or uncoated surface of the optical lens substrate, further typically on both surfaces thereof, by dip coating or by spin coating.

The components of the at least one primer coating composition resulting in at least one primer coating are used in that they add to 100% by weight, based on the total weight of the at least one primer coating composition.

Alternatively, or additionally to the before mentioned at least one primer coating, the coating of the spectacle lens may comprise at least one primer coating based on at least one primer coating composition typically comprising
i) at least one aqueous aliphatic, cycloaliphatic, aromatic or heteroaromatic polyurethane dispersion, at least one aqueous aliphatic, cycloaliphatic, aromatic or heteroaromatic polyurea dispersion, at least one aqueous aliphatic, cycloaliphatic, aromatic or heteroaromatic polyurethane-polyurea dispersion and/or at least one aqueous aliphatic, cycloaliphatic, aromatic or heteroaromatic polyester dispersion, typically at least one aqueous aliphatic polyurethane dispersion or at least one aqueous aliphatic polyester dispersion and more typically at least one aqueous aliphatic polyurethane dispersion,
ii) at least one solvent,
iii) at least one base, and
iv) optionally at least one additive.

The at least one aqueous aliphatic, cycloaliphatic, aromatic or heteroaromatic polyurethane dispersion, at least one aqueous aliphatic, cycloaliphatic, aromatic or heteroaromatic polyurea dispersion, at least one aqueous aliphatic, cycloaliphatic, aromatic or heteroaromatic polyurethane-polyurea dispersion and/or at least one aqueous aliphatic, cycloaliphatic, aromatic or heteroaromatic polyester dispersion is/are present in the at least one primer coating composition in a total amount selected from a range typically of from 2% by weight to 31% by weight, further typically of from 4% by weight to 26% by weight, further typically of from 5% by weight to 21% by weight, more typically of from 6% by weight to 20% by weight and most typically of from 7% by weight to 19% by weight, each based on the total weight of the at least one primer coating composition. The total amount comprises the amount of only one of the dispersions mentioned before or a mixture thereof.

The at least one primer coating composition comprises typically at least one aqueous polyurethane dispersion, wherein the polyurethane comprises a polyester unit as a spacer or the polyurethane dispersion is a polyurethane-polyurea dispersion, characterized by the occurrence of both urethane and urea groups in a macromolecular chain of the polyurethane-polyurea. Such polyurethane dispersions are described for example in WO 94/17116 A1, in particular in WO 94/17116 A1, page 7, lines 11 to 33. The aqueous polyurethane dispersion may be blended with anionically stabilized acrylic emulsions, as described in WO 94/17116 A1, in particular in WO 94/17116 A1, page 7, lines 33 to 35. According to WO 94/17116 A1, page 7, lines 11 to 33, an aqueous polyurethane dispersion typically is a polyurethane-polyurea, i.e., a polymer characterized by the occurrence of both urethane and urea groups in a macromolecular chain.

The aqueous polyurethane dispersion may be blended with anionically stabilized acrylic emulsions as mentioned in WO 94/17166 A1, in particular in WO 94/17116 A1, page 7, lines 33 to 35.

The at least one solvent is present in the at least one primer coating composition in an amount typically from a range of from 69% by weight to 98% by weight, further preferable of from 73% by weight to 96% by weight, more typically of from 76% by weight to 94% by weight and most typically of from 79% by weight to 93% by weight, each based on the total weight of the at least one primer coating composition. The amounts mentioned before applying with regard to one type of solvent as well as with regard to a mixture of different solvents.

As at least one solvent typically at least one organic solvent with a low boiling point of <100° C. under normal pressure and at least one organic solvent with a middle boiling of 100° C. to 150° C. under normal pressure may be used. As at least one organic solvent with a low boiling point methanol, ethanol, 1-propanol, 2-propanol, tert-butanol, acetone, diethyl ether, tert-butylmethyl ether, tetrahydrofuran, chloroform, 1,2-dichlorethane, methylene chloride, cyclohexane, ethyl acetate, n-hexane, n-heptane and/or methyl ethyl ketone for example may be used. Typically, methanol, ethanol, 1-propanol and/or 2-propanol are used as at least one solvent with a low boiling point. As at least one organic solvent with a middle boiling point 1-methoxy-2-propanol, 1-butanol, dibutyl ether, 1,4-dioxan, 3-methyl-1-butanol, 4-hydroxy-4-methyl-2-pentanone, methylisobutylketone and/or toluol for example may be used. Typically, 1-methoxy-2-propanol and/or 4-hydroxy-4-methyl-2-pentanone is/are used as at least one solvent with a middle boiling point.

The weight ratio of the at least one solvent with a low boiling point to the at least one solvent with a middle boiling point is typically 1:1, further typically 1:1.4, more typically 1:1.5 and most typically 1:1.7.

Further, additionally to the at least one solvent with a low boiling point and/or to the at least one solvent with a middle boiling point, the primer coating composition may comprise water. The weight ratio of the at least one solvent with a low boiling point to the at least one solvent with a middle boiling point to water is typically 2:7:1, further typically 2.5:6.5:1, further typically 3:6:1, more typically 3:5:1 and most typically 3:6:1.

Further, the primer coating composition comprises at least one base, which confers a buffering effect with respect to the pH value to the at least one primer coating resulting from that primer coating composition. The at least one base typically retards, more typically inhibits an acidic component to come into contact with an adjacent layer, typically an adjacent layer which is located nearer or next or adjacent to the spectacle lens substrate. The primer coating composition comprises the at least one base in an amount in the range of typically from 0.1% by weight to 3.2% by weight, further typically from 0.2% by weight to 2.8% by weight, further typically from 0.3% by weight to 2.4% by weight, more typically from 0.4% by weight to 1.9% by weight and most typically from 0.5% by weight to 1.6% by weight, each based on the total weight of the primer coating composition. The amounts given before applying to the use of one type of base as well as to the use of a mixture of different bases. The primer coating composition may comprise as at least one base for example imidazole, 1-methylimidazole, 2-methylimidazole, 4-methylimidazole, 2,5-dimethylimidazole, 4-hydroxymethylimidazole, pyrazole, 1,2,3-triazole, 1,2,4-triazole, tetrazole, pentazole, pyrrole, pyrrolidine, pyridine, 4-aminopyridine, 4-methylpyridine, 4-methoxypyridine, 2,4,6-trimethylpyridine, piperidine, piperazine, triethylamine, di-isopropyl amine, di-isobutyl amine, caustic soda and/or caustic potash. Typically, the primer coating composition comprises at least one base selected from the group consisting of 2-methlyimidazole, imidazole, 1-methylimidazole, 4-methylimidazole, 2,5-dimethylimidazole, triethylamine and caustic soda, more typically at least one base selected from the group consisting of 2-methylimidazole, 1-methylimidazole, 4-methylimidazole and caustic soda. Most typically, the primer coating composition comprises at least one base selected from the group consisting of 2-methylimidazole and 1-methylimidazole in an amount of a range from 0.1% by weight to 2% by weight, typically from 0.3% by weight to 1.5% by weight, each based on the total weight the primer coating composition. The amounts mentioned before applying to the use of a mixture of 2-methylimidazole and 1-methylimidazole as well as to the use of 2-methylimidazole or to the use of 1-methylimidazole.

The primer coating composition may comprise optionally at least one additive. The at least one additive may comprise at least one dispersing agent, at least one anti-settling agent, at least one wetting agent, at least one biocide, at least one UV-absorber or mixtures thereof. The at least one additive may be present in the primer coating composition typically in an amount of from 0.01% by weight to 1.7% by weight, further typically in an amount of from 0.07% by weight to 1.4% by weight, more typically in an amount of from 0.09% by weight to 1.1% by weight and most typically in an amount of from 0.1% by weight to 0.7% by weight, each based on the total weight of the primer coating composition. The amounts mentioned before applying with regard to one type of additive as well as with regard to a mixture of different additives.

The primer coating composition comprising the components i) to iv), i.e., the at least one dispersion, the at least one solvent, the at least one base and optionally the at least one additive, after application to at least one precoated or uncoated surface of the spectacle lens substrate, drying and curing results in at least one primer coating.

The primer coating composition resulting in at least one primer coating is typically applied to at least one precoated or uncoated surface of the spectacle lens substrate by dip coating or by spin coating.

The components of the primer coating composition resulting in at least one primer coating are used in that they add to 100% by weight based on the total weight of the primer coating composition.

Antibacterial Coating

An “antibacterial coating” according to the present disclosure is defined as a coating killing 99.9% of at least one type of bacteria as measured according to ISO 22196:2011.

Antiviral Coating

An “antiviral coating” according to the present disclosure is defined as a coating killing 99.9% of at least one type of viruses, such as e.g., enveloped viruses, as measured according to ISO 21702:2019.

Matrix

Antibacterial or antiviral coatings comprise media, agents or active ingredients which provide the antibacterial and/or antiviral properties or media, agents or active ingredients which are the cause for the antibacterial and/or antiviral properties. These media, agents or active ingredients are incorporated in a minor content into a base structure, base material, base compound or base layer. The latter one in the context of the present disclosure is called matrix.

Photochromic Coating

According to Sec. 3.5.11 of ISO 13666:2019 a photochromic lens is defined as a lens (3.5.2) that reversibly changes its luminous transmittance (3.17.6) depending upon the irradiance and wavelength of the optical radiation (3.1.1) to which it is exposed. The lens is designed to react to wavelengths within the solar spectral range, chiefly 300 nm to 450 nm. The transmittance properties are usually affected by ambient temperature. The luminous transmittance of the photochromic lens may vary between a faded state (3.17.11) and a darkened state (3.17.12).

Sec. 3.17.6 of the standard defines luminous transmittance τ_{V} as the ratio of the luminous flux transmitted by the lens (3.5.2) or filter to the incident luminous flux for a specified illuminant and photopic vision. The luminous transmittance is expressed as a percentage and calculated from the following formula:

$$τ = 100 \times \frac{{\int }_{380 nm}^{780 nm} τ ( λ ) {S}_{D 65} ( λ ) V ( λ ) d ( λ )}{{\int }_{380 nm}^{780 nm} {S}_{D 65} ( λ ) V ( λ ) d ( λ )} ,$$

where λ is the wavelength of the light in nanometers; τ(λ) is the spectral transmittance; S_{D65}(λ) is the spectral distribution of the incident radiation of CIE standard illuminant D65 (see ISO 11664-2); V(λ) is the CIE 2° spectral luminous efficiency function for daylight (see ISO 11664-1).

According to Sec. 3.17.11 of ISO 13666:2019 the faded state is the condition of a photochromic lens (3.5.11) before exposure to optical radiation (3.1.1) or after it has been kept in the dark for a period of time. For purposes of testing or reporting which shall be applied in the context of the present disclosure the properties of the lens (3.5.2) or material, ISO 8980-3:2003, now ISO 8980-3:2013(E), specifies a conditioning treatment, after which the luminous transmittance (3.17.6) is given the symbol τᵥ₀.

Sec. 3.17.12 f ISO 13666:2019 defines the darkened state as the condition of a photochromic lens (3.5.11) after exposure to optical radiation (3.1.1). In the context of the present disclosure the properties of the lens (3.5.2) or material, ISO 8980-3:2003, now ISO 8980-3:2013(E), specifies defined exposures, intensities of irradiation and temperatures for testing. In ISO 8980-3:2003, the luminous transmittances (3.17.6) in these states are given the symbols τ_{V1}, τ_{VW}, τ_{VS} and τ_{VA}.

A photochromic coating according to the present disclosure is any coating that provides above photochromic properties to the respective spectacle lens. Photochromic coating shall not include coatings for which the photochromic effect is negligible, namely because the variation of luminous transmittance between the faded state and the darkened state is for example below 1.1 according to the definitions described in the forgoing.

According to an exemplary embodiment of the present disclosure, the coating of the spectacle lens may comprise a photochromic coating. Typically, only the precoated or uncoated finished front surface of the spectacle lens substrate comprises or is coated with a photochromic coating. If a spectacle lens comprises at least one hard coating, optionally at least one primer coating and at least one photochromic coating, typically the at least one photochromic coating is the coating next, but not necessarily adjacent, to the surface of the spectacle lens substrate to be coated and the hard coating is the coating furthest away from the surface. The surface of the spectacle lens substrate typically is optically finished and may be precoated or uncoated. In case the spectacle lens comprises at least one hard coating, optionally at least one primer coating, at least one photochromic coating and at least one antibacterial and/or antiviral coating, typically the at least one photochromic coating is the coating next to, but not necessarily adjacent to, the surface of the spectacle lens substrate to be coated, whereas the at least one antibacterial and/or antiviral coating is the coating furthest away from the surface. The at least one photochromic coating may for example be based on a photochromic composition described in EP 1 433 814 A1, EP 1 602 479 A1 or EP 1561571 A1.

EP 1 433 814 A1, in particular EP 1 433 814 A1, claim 1, discloses a photochromic composition comprising (1) 100 parts by weight of radically polymerizable monomers; (2) 0.01 to 20 parts by weight of an amine compound; and (3) 0.01 to 20 parts by weight of a photochromic compound, the radically polymerizable monomers including a radically polymerizable monomer having a silanol group or a group which forms a silanol group by hydrolysis, and/or a radically polymerizable monomer having an isocyanate group. According to EP 1 433 814 A1 to increase adhesion between the photochromic coating resulting from the photochromic composition described therein and a spectacle lens substrate, a radically polymerizable monomer having a silanol group or a group which forms a silanol group by hydrolysis or a radically polymerizable monomer having an isocyanate group is used. Usable monomers are mentioned in EP 1 433 814 A1, page 3, paragraph [0025], to page 7, paragraph.

Additionally, according to EP 1 433 814 A1 the photochromic composition may include other radically polymerizable monomers. As other polymerizable monomers, a combination of a radically polymerizable monomer having a homopolymer L-scale Rockwell hardness of at least 60 (“high-hardness monomer”) and a radically polymerizable monomer having a homopolymer L-scale Rockwell hardness of 40 or less (“low-hardness monomer”) is typically used to improve the characteristic properties such as solvent resistance, hardness and heat resistance of the resulting photochromic coating or the photochromic properties thereof such as color development intensity and fading speed. Examples and explanations with respect to the high-hardness monomers and the low-hardness monomers are given in EP 1 433 814 A1, page 7, paragraph [0052], to page 13, paragraph [0096]. To improve the balance of the characteristic properties such as solvent resistance, hardness and heat resistance or photochromic properties such as color development intensity and fading speed of the resulting photochromic coating, the amount of a low-hardness monomer is typically 5 to 70% by weight and the amount of a high-hardness monomer is typically 5 to 95% by weight based on the total of all the other radically polymerizable monomers excluding the radically polymerizable monomer having a silanol group or a group which forms a silanol group by hydrolysis and the radically polymerizable monomer having an isocyanate group. Further, according to EP 1 433 814 A1, it is particularly typical that a monomer having at least three radically polymerizable groups should be contained as the high-hardness monomer in an amount of at least 5% by weight based on the total of all other radically polymerizable monomers. Further typically, according to EP 1 433 814 A1, the radically polymerizable monomers include a radically polymerizable monomer having at least one epoxy group and at least one radically polymerizable group in the molecule besides the mentioned monomers classified by hardness. The durability of a photochromic compound and the adhesion of the photochromic coating can be improved by using the radically polymerizable monomer having at least one epoxy group. Radically polymerizable monomers having at least one epoxy group and at least one radically polymerizable group in the molecule are disclosed in EP 1 433 814 A1, page 13, paragraph [0101], to page 14, paragraph [0105]. According to EP 1 433 814 A1, the amount of the radically polymerizable monomer having at least one epoxy group and at least one radically polymerizable group in the molecule is typically 0.01 to 30% by weight, particularly typically 0.1 to 20% by weight based on the total of all other radically polymerizable monomers. The photochromic composition described in EP 1 433 814 A1 comprises at least one amine compound in an amount of 0.01 to 20 parts by weight based on 100 parts by weight of the total of all the radically polymerizable monomers in addition to the above mentioned radically polymerizable monomers. Examples for the at least one amine compound is given in EP 1 433 814 A1, page 14, paragraph [0108], to page 15, paragraph [0112]. The photochromic composition disclosed in EP 1 433 814 A1 comprises at least one photochromic compound in an amount of 0.01 to 20 parts by weight, typically 0.05 to 15 parts by weight and more typically 0.1 to 10 parts by weight based on 100 parts by weight of the total of all radically polymerizable monomers. Examples for photochromic compounds are given in EP 1 433 814 A1, page 15, paragraph [0114] to page 20, paragraph [0122].

EP 1 602 479 A1, in particular EP 1 602 479 A1, claim 9, discloses a photochromic composition comprising 100 parts by weight of a radically polymerizable monomer, 0.001 to 5 parts by weight of a silicone base or fluorine base surfactant and 0.01 to 20 parts by weight of a photochromic compound. According to EP 1 602 479 A1, the photochromic composition comprises a radically polymerizable monomer having a silanol group or a group which forms a silanol group by hydrolysis, an amine compound and a photochromic compound. The use amount of the radically polymerizable monomer having a silanol group or a group which forms a silanol group by hydrolysis is suitably 0.5 to 20% by weight, particularly 1 to 10% by weight based on the total weight of the whole coating agents. Other radically polymerizable monomers which according to EP 1 602 479 A1 can be used together with the radically polymerizable monomer having a silanol group or a group which forms a silanol group by hydrolysis, such as for example trimethylolpropane trimethacrylate, trimethylolpropane triacrylate, tetramethylolmethane trimethacrylate, tetramethylolmethane triacrylate, trimethylolpropane triethylene glycol triacrylate, pentaerythritol tetramethacrylate, dipentaerythritol hexaacrylate, urethane oligomer tetraacrylate, urethane oligomer hexamethacrylate, urethane oligomer hexaacrylate, polyester oligomer hexaacrylate, diethyleneglycol dimethacrylate, triethyleneglycol dimethacrylate, tetraethyleneglycol dimethacrylate, tripropyleneglycol dimethacrylate, bisphenol A dimethacrylate, 2,2-bis(4-methacryloyloxyethoxydiphenyl)propane, glycidyl methacrylate, 2,2-bis(4-acryloyloxypolyethylene glycol phenyl)propane having an average molecular weight of 776 or methyl ether polyethylene glycol methacrylate having an average molecular weight of 475. The use amount of the other radically polymerizable monomers is suitably 20 to 90% by weight, particularly 40 to 80% by weight based on the weight of the whole coating agents. The use amount of the amine compound, such as triethanolamine, N-methyldiethanolamine, triisopropanolamine, N,N-dimethylaminoethyl methacrylate or N,N-diethylaminoethyl methacrylate for example, is suitably 0.01 to 15% by weight, particularly 0.1 to 10% by weight based on the weight of the whole coating agents. The use amount of the photochromic compound such as a naphthopyran derivative, a chromene derivative, a spirooxazine derivative, a spiropyran derivative or a fulgimide derivative is suitably 0.1 to 30% by weight, particularly 1 to 10% by weight based on the weight of the whole coating agents.

In case the spectacle lens comprises at least one photochromic coating, typically the front surface of the uncoated or precoated spectacle lens substrate comprising the at least one photochromic coating, the spectacle lens may optionally comprise at least one photochromic primer. Typically the front surface of the spectacle lens substrate comprises the at least one photochromic primer and the at least one photochromic coating, the photochromic coating being the outermost coating thereof. The at least one photochromic primer may comprise the polyurethane resin layer disclosed in EP 1 602 479 A1, in particular in EP 1 602 479 A1, claim 1, or the primer layer disclosed in WO 03/058300 A1, in particular in WO 03/058300 A1, page 22, line 3 to page 23, line 13.

Mirror Coating

High-reflection (HR) coatings or dielectric mirror coatings work the opposite way to antireflection coatings. The term “mirror coating” designates in the context of the present disclosure any coating any coating that enhances the reflectivity above the values of the reflectivity of an uncoated substrate, in a wavelength range that is larger than 50 nm.

According to an exemplary embodiment of the present disclosure, the spectacle lens may comprise a mirror coating. A mirror coating typically comprises alternating dielectric layers in the manner of a Bragg mirror and/or at least one semitransparent metal layer. The at least one semitransparent metal layer may comprise, for example, an aluminum layer, chromium layer, gold layer and/or silver layer, typically a silver layer. The layer thickness of the semitransparent metal layer is typically within a range of from 4 nm to 48 nm, more typically within a range of from 8 nm to 41 nm and most typically within a range of from 17 nm to 33 nm. The at least one semitransparent metal layer is typically applied by means of a physical vapor deposition method.

Anti-Reflective Coating

Sec. 3.18.3 of ISO 13666:2019 defines “anti-reflective coating” or “antireflection coating” as a coating on the surface of a lens (3.5.2) intended to reduce light (3.1.2) reflected from its surfaces.

The term “anti-reflective coating” or “antireflection coating” designates in the context of the present disclosure according to any coating reducing light (3.1.2) reflected from its surfaces such that the value for the light reflection factor ρν as determined and defined according to Sec. 4.2 of EN ISO 8980-4:2006 is less than 2.5%. It is to be noted that any coating or layer not contributing to the anti-reflective properties of the spectacle lens shall not constitute a part of the anti-reflective coating. This means for example that a so called V/2-layer does not constitute part of an anti-reflective coating since it does not contribute to the anti-reflective properties of the coating. For that reason such a layer is also called an absentee layer. A primer layer and a hard coating layer regularly does also not constitute a part of the anti-reflective coating since the thickness exceeds the wavelength of visible light and the refractive index is close to that of the spectacle lens substrate. The contribution to the anti-reflecting properties is negligible. A clean coating layer shall not constitute a part of the anti-reflective coating since due to its thickness of below 6 nm as the top layer with a refractive index close to the underlying layer the contribution to the anti-reflecting properties is negligible.

Many anti-reflective coatings consist of transparent thin film structures with alternating layers of contrasting refractive index. Layer thicknesses are chosen to produce destructive interference in the beams reflected from the interfaces, and constructive interference in the corresponding transmitted beams. This makes the structure's performance change with wavelength and incident angle, so that color effects often appear at oblique angles.

The spectacle lens comprises typically at least one antireflective coating. The at least one antireflective coating typically comprises alternating discrete metal oxide, metal hydroxide and/or metal oxide hydrate layers composed of or comprising aluminum, silicon, zirconium, titanium, yttrium, tantalum, neodymium, lanthanum, niobium and/or praseodymium. The at least one antireflective coating typically comprises at least one layer of a metal oxide, metal hydroxide and/or metal oxide hydrate layer composed of or comprising silicon, which typically forms the outermost layer of the antireflective coating. The antireflective coating typically comprises a coating stack of at least one layer with a high refractive index (HRI) and of at least one layer with a low refractive index (LRI). There may be also layers of intermediate reflective index (IRI).

There is no limitation for the number of layers. However, from the perspective of broadband reflection reduction, the layer total number in the antireflective coating is typically higher than or equal to 3, further typically higher than or equal to 5, and lower than or equal to 9.

Typically, the HRI layers have a physical thickness ranging from 10 to 120 nm and the LRI layers have a physical thickness ranging from 10 to 100 nm. The at least one antireflective coating typically has a total layer thickness from a range from 100 nm to 1000 nm, typically from a range from 110 nm to 800 nm, further typically from a range from 120 nm to 750 nm, more typically from a range from 130 nm to 700 nm and most typically from a range from 140 nm to 500 nm.

The at least one antireflective coating may be designed with respect to the desired optical properties thereof typically by using the software OptiLayer, version 12.37, of company OptiLayer GmbH, 85748 Garching b. München, or the software Essential MacLeod, version 11.00.541, of company Thin Film Center Inc., 2745 E Via Rotunda, Tucson, Ariz. USA. For designing the at least one antireflective coating, the respective refractive indices of the layer materials typically are assumed to be wavelength dependent. In case the antireflective coating comprises at least one layer of SiO₂ and at least one layer of TiO₂, the designing the antireflective coating typically is based on a refractive index for TiO₂ of n=2.420 at 550 nm and a refractive index for SiO₂ of n=1.468 at 550 nm.

The at least one antireflective coating may comprise the layer sequence and the layer thickness indicated in EP 2 437 084 A1, in FIGS. 3 and 5, in each case between the superhydrophobic layer and the hard lacquer layer or the layer sequence and the layer thicknesses disclosed in paragraph [0056] of EP 2 801 846 A1.

In a spectacle lens comprising at least one hard coating and at least one antireflective coating, the at least antireflective coating typically forms the outermost coating. The antireflective coating is typically disposed on top of the at least one hard coating on the eye side and/or object side of the spectacle lens.

Cluster

In the context of the present disclosure “cluster” shall mean a collection of atoms or molecules comprising between 3 and 10 million of atoms or molecules, typically between 10² and 107 atoms or molecules, further typically between 10² and 2-106 atoms or molecules. The atoms or molecules within a cluster may be of the identical type or of a different type.

Antistatic Coating

According to Sec. 3.18.8 of the standard ISO 13666:2019 an anti-static coating is a coating on the surface of a lens (3.5.2) intended to reduce static electricity on the surface, in order to reduce the attraction of dust. Antistatic properties may be determined by measuring the surface resistivity of a coated lens. In the context of the present disclosure, a spectacle lens with an anti-static coating has a surface resistivity of below 2×10¹² Ohm/square as compared to a spectacle lens substrate having a surface resistivity of more than 2×10¹² Ohm/square.

In one exemplary embodiment of the present disclosure, the spectacle lens may comprise at least one electrically conductive or semiconductive (but still transparent) layer. The at least one electrically conductive or semiconductive layer may comprise, for example, a layer composed of or comprising indium tin oxide ((In₂O₃)_{0.9} (SnO₂)_{0.1}; ITO), fluorine tin oxide (SnO₂:F; FTO), aluminum zinc oxide (ZnO:Al; AZO) and/or antimony tin oxide (SnO₂:Sb; ATO). Typically, the electrically conductive or semiconductive layer comprises a layer composed of or comprising ITO or composed of or comprising FTO. An electrically conductive or semiconductive layer arranged as the outermost layer of the spectacle lens on the object side and/or eye side reduces or avoids the static charging of the spectacle lens. This in turn facilitates the cleaning of the spectacle lens. The at least one electrically conductive or semiconductive layer may be one of the layers of the antireflective coating.

Typically the at least one antireflective coating is manufactured by physical vapor deposition, typically by means of electron beam evaporation or thermal evaporation in a vacuum chamber.

Clean Coating

According to Sec. 3.18.4 of ISO 13666:2019 a clean coating is a coating on the surface of a lens (3.5.2) intended to make the surface repel dust and grease and/or to make it easier to clean.

The term “clean coating” designates in the context of the present disclosure any coating providing aforementioned properties.

Typically the water contact angle of the at least one clean coat layer lies in a range of from 900 to 120°, more typically in a range of from 1050 to 115°. The water contact angle typically is determined by means of an OCA 20 contact angle meter from DataPhysics Instruments using deionized water with a droplet size of 1 and 10 μL as liquid.

The at least one clean coat component may confer oleophobic or hydrophobic properties to the clean coat layer. Oleophobic of hydrophobic properties of a clean coat layer are disclosed for example in EP 1 392 613 A1, wherein water forms a contact angle of more than 90°, typically of more than 1000 and particularly of more than 110°. The at least one clean coat component may comprise for example at least one fluoro organic component covalently bonding to an underneath adjacent coating as disclosed in DE 198 48 591 A1, claim 1, or at least one component based on perfluoropolyethers. The at least one clean coat component typically is of hydrophobic nature to ensure the spectacle lens to having an easy to clean surface. Typical contaminations on the surface of a spectacle lens could then be easily removed by liquid droplets, typically water droplets, just rolling off or rolling of in combination with wiping. The at least one clean coat component comprises typically at least one silane having at least one fluorine-containing group, which exhibits typically more than 20 carbon atoms. Per- or polyfluoroalkyl compounds (PFAS) with silane functionality that comprise at least one —(CF₂)ₓ-unit (x≥1) are commonly used.

The at least one clean coat layer typically comprises perfluoropolyethers, perfluoroalkyl silanes and/or perfluoroalkyl siloxanes. The at least one clean coat layer is typically applied by vacuum deposition, described above.

Hydrophobic Coating

According to Sec. 3.18.5 of ISO 13666:2019 a hydrophobic coating encompasses a coating on the surface of a lens (3.5.2) intended to repel water droplets.

Hydrophilic Coating

Sec. 3.18.6 of ISO 13666:2019 defines “hydrophilic coating” as a coating on the surface of a lens (3.5.2) intended to wet very easily, so that any water droplets on it spread and coalesce to a uniform film on the surface.

Anti-Fog Coating

An “anti-fog coating” is described according to Sec. 3.18.7 ISO 13666:2019 as a hydrophobic (3.18.5) or hydrophilic coating (3.18.6) on the surface of a lens (3.5.2) intended to reduce blur caused by droplets of condensed water vapor on the lens' surface when a relatively cold lens is put into a warmer, humid environment.

In case the spectacle lens comprises at least one anti-fog coating and at least one clean coat layer, the at least one clean coat layer typically is the outermost coating thereof.

An anti-fog coating may comprise an antifogging resin or surfactant, including highly hydrophilic polymers such as polyvinyl alcohol, (sodium) polyacrylate, or polyurethane comprising hydrophilic groups. For example, commercially available are anti-fog resins under the names UVAF, AFC-GW, AFC-133P12G, AFC-SW6M and AFC-G*NK from Gelwell Biotech Corp. or Visgard Premium, Visgard Premium SE, Visgard Premium Plus and Visgard Elite from FSI Coating Technologies, Inc.

The average thickness of the al least one anti-fog coating is not subject to any special constraint. The average thickness of the at least one anti-fog coating lies typically in a range of from 1 μm to 20 μm, further typically in a range of from 2 μm to 17 μm, more typically in a range of from 3 μm to 15 μm, most typically in a range of from 4 μm to 12 μm and particularly typically in a range of from 5 μm to 10 μm. The average thickness is typically determined by at least one scanning electron microscope photograph of a cross-section of the spectacle lens comprising at least a spectacle lens substrate and at least one anti-fog coating. In the at least one scanning electron microscope photograph, the physical thickness of the at least one anti-fog coating is determined in at least three positions and the arithmetic average is formed thereof.

Data Carrier

Data carrier is any medium that is capable of holding computer-readable data. Examples are the hard drives and thumb drives used with computers.

Data Carrier Signal

Data carrier signal is a structure of how information is transferred or transmitted, e.g., in a network; the data carrier signal may be transferred or transmitted as a modulation such as in binary code or in pulses and may be contained in a packet.

In one first exemplary embodiment of the disclosure as claimed in claim 1 the spectacle lens comprises
(i) an anti-reflective coating or
(ii) a mirror coating.

The (i) anti-reflective coating or the (ii) mirror coating consists of a stack of a plurality of stack layers. The outermost stack layer, i.e., the layer of the plurality of layers of the stack which is farthest away from a spectacle lens substrate comprises silver (Ag). The silver is intended to provide antibacterial and/or antiviral properties.

According to the disclosure the outermost stack layer constitutes a SiO₂-matrix comprising a plurality of individual silver (Ag) atoms and/or a plurality of silver (Ag) clusters. Such a silver (Ag) cluster may have a maximum expansion of less than 20 nm. Typically, the size of such silver clusters has a dimension which does not exceed 15 nm or even 10 nm. Maximum expansion means the dimension with the biggest expansion. The maximum expansion of a sphere is its diameter. A maximum expansion of an ellipsoid is the longest of its symmetry or principle axes. Since increasing sizes of silver clusters reduce transmission of the spectacle lens the size of the clusters may not exceed such values.

On the other hand, the size of the clusters influences the antiviral properties of the spectacle lens. It has been found out that the size expressed in terms of maximum expansion shall not be below 2 mm, typically not below 5 nm.

It shall be mentioned here, that (i) anti-reflective coatings or (ii) mirror coatings according to the disclosure comprising such antiviral or antibacterial active stack layers may be applied to one or both of the spectacle lens substrate's main surfaces. The spectacle lens substrate may be covered by an anti-reflective coating or a mirror coating on one of its surfaces having no such antiviral or antibacterial active stack layers. Typically, at least on the front surface of the spectacle lens an (i) anti-reflective coating or a (ii) mirror coating according to the disclosure having such silver atoms or silver clusters is applied. This measure shall prevent from being infected by injurious viruses and bacteria being exhaled by third persons.

In a typical exemplary embodiment of the disclosure a substance proportion of the silver (Ag) in the SiO₂-matrix is lower than 1.5 at % (atomic percent), typically less than 1.3 at % and more typically less than 1.2 at %. It has been found out that in case the substance proportion of the silver (Ag) in the SiO₂-matrix being in the range between 0.8 at % and 1.5 at %, or if the substance proportion of the silver (Ag) in the SiO₂-matrix being in the range between 0.9 at % and 1.3 at %, or if the substance proportion of the silver (Ag) in the SiO₂-matrix being in the range between 1.0 at % and 1.2 at %, or even in case the substance proportion of the silver (Ag) in the SiO₂-matrix being in the range between 1.05 at % and 1.15 at % transmission properties as well as antibacterial/antiviral properties are most suitable in order to fulfill the spectacle lens wearer's needs.

An alternative second exemplary embodiment to the first exemplary embodiment described above is a spectacle lens which comprises
(i) an anti-reflective coating or
(ii) a mirror coating.

The (i) anti-reflective coating or the (ii) mirror coating consist of a stack of a plurality of stack layers. The stack comprises an outermost stack layer. The outermost stack layer comprises silver (Ag). According to the disclosure the outermost stack layer constitutes a SiO₂-matrix comprising the silver (Ag). A substance proportion of the silver (Ag) in the SiO₂-matrix shall be within at least one of the following ranges, namely: The substance proportion of the silver (Ag) in the SiO₂-matrix is less than 1.5 at %, or less than 1.3 at %, or even less than 1.2 at %. Typically, there is also a lower limitation with respect to the silver content: Therefore, the substance proportion of the silver (Ag) in the SiO₂-matrix is typically in the range between 0.8 at % and 1.5 at %, more typically between 0.9 at % and 1.3 at %, even more typically between 1.0 at % and 1.2 at %. Most typically, the substance proportion of the silver (Ag) in the SiO₂-matrix is in the range between 1.05 at % and 1.15 at %. Transmission properties as well as antibacterial/antiviral properties are thus adjusted to fulfill a spectacle lens wearer's needs with respect to transparency and health related antiviral/antibacterial effect.

Another alternative third exemplary embodiment is directed to a spectacle lens comprising
(i) an anti-reflective coating or
(ii) a mirror coating.

The (i) anti-reflective coating or the (ii) mirror coating consist of a stack of a plurality of stack layers. The stack comprises an outermost stack layer. At least the outermost stack layer comprises silver (Ag).

According to the disclosure, the silver (Ag) in at least the outermost stack layer and as the case may be in other layers of the stack or even underneath or on top thereof have (all together) a content causing a photochromic effect. The content of the silver (Ag) in at least the outermost stack layer is set such that (in combination with all other layers comprising silver) a variation of a luminous transmittance (τ_{T0}) of the spectacle lens between a faded state according to 7.5.3.2 of ISO 8980-3:2013(E) and a luminous transmittance (τ_{V1}) of the spectacle lens in a darkened state according to 7.5.3.3 of ISO 8980-3:2013(E) caused by the photochromic effect is within a range of the following group:
(A) τ_{V1}/τ_{V0}≤0.95,
(B) τ_{V1}/τ_{V0}≤0.98,
(C) 0.95≤τ_{V1}/τ_{V0}≤0.995,
(D) 0.98≤τ_{V1}/τ_{V0}≤0.995,
(E) 0.985≤τ_{V1}/T_{V0}≤0.995.

The inventors have found out that such adjustment encompasses transmission properties as well as antibacterial/antiviral properties being thus adjusted to fulfill the needs of a spectacle lens wearer with respect to increased/sufficient transparency and increased/sufficient health related antiviral/antibacterial effect.

In a typical but optional exemplary embodiment the luminance transmittance □_{V0} in the faded state as defined in 7.5.3.2 of ISO 8980-3: 2013(E) exceeds a value of 95%, typically 96%, most typically 97%.

Still another fourth alternative exemplary embodiment is directed to a spectacle lens comprising a spectacle lens substrate and
(i) an anti-reflective coating or
(ii) a mirror coating.

The (i) anti-reflective coating or the (ii) mirror coating consist of a stack of a plurality of stack layers. The stack comprises an outermost stack layer. The outermost stack layer comprises silver (Ag). The outermost stack layer has an outer surface facing away from the spectacle lens surface.

According to the disclosure the (i) anti-reflective coating or the (ii) mirror coating are designed to have a diffusivity (D_{F}) configured to ensure an absorption of water molecules passing through the (i) anti-reflective coating or the (ii) mirror coating into the spectacle lens substrate and a release of water molecules from the spectacle lens substrate through the (i) anti-reflective coating or the (ii) mirror coating from an air atmosphere arranged on the outer surface of the outermost stack layer. The air atmosphere has a moisture flow density (j_{D}). The diffusivity (D_{F}) is further configured to, starting from a first equilibrium state of the amount of water molecules absorbed in the spectacle lens substrate at an air atmosphere at 23 degrees centigrade and 50 percent relative humidity, effect a setting of a second equilibrium state of the amount of water molecules absorbed in the spectacle lens substrate at an air atmosphere at 40 degrees centigrade and 95 percent relative humidity within a first time interval. The first time interval being at most ten hours longer than a second time interval required for a setting of the second equilibrium state starting from the first equilibrium state in an uncoated spectacle lens substrate identical to the spectacle lens substrate. Guidelines for manufacturing coatings having such diffusivity properties for water molecules are disclosed in U.S. Pat. No. 9,778,484 B2.

Providing such diffusivity properties to the coating of a spectacle lens being designated to provide antiviral and/or antibacterial effect enables water to enter into the coating and to leave the coating together with dissolved silver ions which are prerequisite for the antiviral and/or antibacterial efficacy.

Still another fifth alternative exemplary embodiment is directed to a spectacle lens comprising
(i) an anti-reflective coating or
(ii) a mirror coating.

The (i) anti-reflective coating or the (ii) mirror coating consist of a stack of a plurality of stack layers. The stack comprises an outermost stack layer. At least the outermost stack layer comprises silver (Ag).

According to the disclosure the silver (Ag) in at least the outermost stack layer has a content such that upon releasing silver (Ag) ions from the spectacle lens by exposing the spectacle lens to 10 ml of deionized water at 23 degrees centigrade for six hours a silver (Ag) ion concentration of at least 0.1 mg/l, typically at least 0.12 mg/l, most typically at least 0.15 mg/l being dissolved in the deionized water is measured.

Similar to the foregoing alternative exemplary embodiment, the manufacturing of the spectacle lens is adjusted that respective diffusivity properties are fulfilled. Providing e.g., such diffusivity properties typically in combination with the above described amount of silver and/or the above described cluster formation in the outermost stack layer and/or the above described entire coating structure of the spectacle lens, the spectacle lens is suitable to provide the antiviral and/or antibacterial effect. In particular, the spectacle lens properties described in the foregoing enable water to enter into the coating and to leave the coating together with dissolved silver ions which are prerequisite for the antiviral and/or antibacterial efficacy.

In a typical exemplary embodiment the spectacle lens according to one of the third to fifth exemplary embodiments according to the disclosure may be wherein the outermost stack layer is a SiO₂-matrix comprising the silver (Ag). This exemplary embodiment has the advantage that a SiO₂-layer is commonly used as an outermost stack layer of an anti-reflective or mirror coating and a certain amount of silver may be incorporated into the base material matrix of the SiO₂-layer using typical anti-reflective or mirror coating deposition technology.

The inventors have found out that the geometry as well as chemical state of the silver significantly influences both optical as well as antiviral/antibacterial properties. Therefore, according to a further typical exemplary embodiment of the foregoing exemplary embodiment the deposition parameters for the fabrication of the outermost stack layer are adjusted such that at least a part of the silver (Ag) in the SiO₂-matrix forms clusters having a maximum expansion of less than 20 nm, typically of less than 15 nm and more typically of less than 10 nm. The typical minimum size of such clusters expressed in terms of maximum expansion has been identified to be between 2 mm and 5 mm. Such size constitutes a compromise between a sufficient transparency of the spectacle lens and sufficient antiviral/antibacterial activity.

According to another typical exemplary embodiment of the disclosure the spectacle lens as described in the two previously described exemplary embodiments is further wherein at least a part of the silver (Ag) in the SiO₂-matrix are silver (Ag) atoms being interstitially arranged in the SiO₂-matrix. In contradiction to a chemical bond to oxygen or—as the case may be—to an incorporation in the lattice structure as such an interstitial arrangement of Ag in the SiO₂-matrix provides capability of dissolution in water constituting a prerequisite of antiviral and/or antibacterial activity.

A typical exemplary embodiment of a spectacle lens being a development of or being applicable to all exemplary embodiments described above is wherein the outermost stack layer has a thickness within at least one of the following ranges:
i. the outermost stack layer having a thickness in a range of 5 nm to 50 nm
ii. the outermost stack layer having a thickness in a range of 5 nm to 40 nm
iii. the outermost stack layer having a thickness in a range of 5 nm to 30 nm
iv. the outermost stack layer having a thickness in a range of 5 nm to 20 nm
v. the outermost stack layer having a thickness in a range of 5 nm to 15 nm

Such thickness ranges for the outermost stack layer are suitable to be applied to typical AR- or mirror coating stacks. The lower limit is a result of providing sufficient antiviral and/or antibacterial activity. The upper limit is a result of a relationship between providing sufficient antiviral and/or antibacterial activity, providing sufficient transparency to the spectacle lens, providing the interference effect required and limiting the overall content of silver to the required amount.

The inventors in addition have found out that the overall optical and antiviral/antibacterial properties may be improved if not only the outermost stack layer comprises a certain amount of silver but also stack layers underneath. Therefore, according to a typical exemplary embodiment of a spectacle lens according to the disclosure at least one of the stack layers in addition to the outermost stack layer may comprise silver (Ag).

Typically, for the same reasons as described in detail above with reference to the outermost stack layer at least a part of the silver (Ag) in the at least one of the stack layers in addition to the outermost stack layer forms clusters. The silver (Ag) clusters in the at least one of the stack layers in addition to the outermost stack layer have a typical maximum expansion within at least one of the following ranges:
(a) the silver (Ag) clusters having a maximum expansion of less than 20 nm
(b) the silver (Ag) clusters having a maximum expansion of less than 15 nm
(c) the silver (Ag) clusters having a maximum expansion of less than 10 nm
(d) the silver (Ag) clusters having a maximum expansion in the range of 2 nm to 20 nm
(e) the silver (Ag) clusters having a maximum expansion in the range of 2 nm to 15 nm
(f) the silver (Ag) clusters having a maximum expansion in the range of 2 nm to 10 nm
(g) the silver (Ag) clusters having a maximum expansion in the range of 5 nm to 20 nm
(h) the silver (Ag) clusters having a maximum expansion in the range of 5 nm to 15 nm
(i) the silver (Ag) clusters having a maximum expansion in the range of 5 nm to 10 nm.

Another typical exemplary embodiment according to the disclosure is wherein at least one of the at least one of the stack layers in addition to the outermost stack layer comprising the silver (Ag) constitutes a TiO₂-layer comprising the silver (Ag) as an option. The inventors have found out that a TiO₂-matrix is suitable to accumulate or incorporate silver upon manufacturing and in addition is suitable to release silver ions as soon as getting in contact with water even in case such layers are covered by other stack layers. Such layer structure both may improve antiviral and/or antibacterial properties without significantly negatively affecting optical, in particular transmission properties of the overall spectacle lens.

The inventors have found out that both improvement of antiviral and/or antibacterial properties without significantly negatively affecting optical, in particular transmission properties of the overall spectacle lens may for example be achieved if a substance proportion of the silver (Ag) in the TiO₂-matrix lies within at least one of the following ranges:
a) the substance proportion of the silver (Ag) in the TiO₂-matrix being less than 0.9 at %
b) the substance proportion of the silver (Ag) in the TiO₂-matrix being less than 0.8 at %
c) the substance proportion of the silver (Ag) in the TiO₂-matrix being less than 0.7 at %
d) the substance proportion of the silver (Ag) in the TiO₂-matrix being in the range between 0.2 at % and 0.9 at %
e) the substance proportion of the silver (Ag) in the TiO₂-matrix being in the range between 0.25 at % and 0.8 at %
f) the substance proportion of the silver (Ag) in the TiO₂-matrix being in the range between 0.3 at % and 0.75 at %
g) the substance proportion of the silver (Ag) in the TiO₂-matrix being in the range between 0.35 at % and 0.7 at %.

In addition, or alternatively at least one of the at least one of the stack layers in addition to the outermost stack layer may optionally be a SiO₂-matrix comprising silver (Ag) constituting a SiO₂-layer comprising the silver (Ag). Interference layers comprising a plurality of alternatively arranged TiO₂ and SiO₂ may form AR- or mirror-coatings.

In a further typical exemplary embodiment according to the disclosure described above the spectacle lens may optionally further be wherein a substance proportion of the silver (Ag) in the SiO₂-matrix of the at least one of the at least one of the stack layers in addition to the outermost stack layer being within at least one of the following ranges:
a) the substance proportion of the silver (Ag) in the SiO₂-matrix being less than 0.25 at %
b) the substance proportion of the silver (Ag) in the SiO₂-matrix being less than 0.2 at %
c) the substance proportion of the silver (Ag) in the SiO₂-matrix being less than 0.15 at %
d) the substance proportion of the silver (Ag) in the SiO₂-matrix being in the range between 0.01 at % and 0.25 at %
e) the substance proportion of the silver (Ag) in the SiO₂-matrix being in the range between 0.01 at % and 0.2 at %
f) the substance proportion of the silver (Ag) in the SiO₂-matrix being in the range between 0.01 at % and 0.15 at %.

According to another exemplary embodiment the spectacle lens may optionally be wherein a substance proportion of silver (Ag) in a SiO₂-matrix of a first stack layer is lower than a substance proportion of silver (Ag) in a TiO₂-matrix of a second stack layer adjacent to the first stack layer.

According to still another exemplary embodiment the spectacle lens may optionally be wherein the outermost stack layer constituting either a top coating layer or a layer underneath and adjacent to a top coating/top coating layer.

According to another exemplary embodiment the spectacle lens may optionally be wherein the top coating layer being one of a clean coating, a hydrophobic coating, a hydrophilic coating or an anti-fog coating.

According to still further exemplary embodiment the spectacle lens may optionally be characterized in comprising at least one of a hard coating, a primer coating, a photochromic coating, an anti-static coating, an adhesion promoting layer or a binding layer.

Another typical exemplary embodiment of the disclosure is wherein a content of the silver (Ag) in the spectacle lens is optionally set to killing 99.9% of enveloped viruses as measured according to ISO 21702:2019.

Still another typical exemplary embodiment of the disclosure is wherein a content of the silver (Ag) in the spectacle lens is optionally set to killing 99.9% of bacteria as measured according to ISO 22196:2011.

A further typical exemplary embodiment of the disclosure is directed to a spectacle lens in the form of computer-readable data. The computer-readable data of the spectacle lens may be
(i) stored on a computer-readable data carrier, or
(ii) in the form of a data carrier signal.

Typically, the computer-readable data of the spectacle lens comprise a representation of the spectacle lens. The representation of the spectacle lens typically comprises the mathematical description of the surfaces of the spectacle lens or of the spectacle lens substrate, in particular the mathematical description of the front surface and of the back surface (i) of the spectacle lens or (ii) of the spectacle lens substrate. Further typically, the representation of the spectacle lens comprises the arrangement of the front surface to the back surface (i) of the spectacle lens or (ii) of the spectacle lens substrate. The arrangement of the front surface to the back surface may additionally comprise the thickness, such as in particular the edge thickness and/or the centre thickness, and/or the edge (i) of the spectacle lens or (ii) of the spectacle lens substrate.

Further typically, the computer-readable data of the spectacle lens comprise the optical material the spectacle lens substrate is based on.

Further typically, the computer-readable data of the spectacle lens comprise the coating sequence of the stack of the plurality of stack layers and composition of each stack layer.

The computer-readable data of the spectacle lens may comprise instructions for using the spectacle lens. The instructions for using the spectacle lens may be selected from at least one of the instructions selected from the group consisting of the centration point position, defined according to ISO 13666:2019(E), section 3.2.35; the face form angle, defined according to ISO 13666:2019(E), section 3.2.29; the vertex distance, defined according to ISO 13666:2019(E), section 3.2.40; the distance reference point, defined according to ISO 13666:2019(E), section 3.2.20; and the optionally the near reference point, defined according to ISO 13666:2019(E), section 3.2.21.

The computer-readable data of the spectacle lens may be encrypted or not encrypted.

A further typical exemplary embodiment of the disclosure is directed to computer-readable instructions to produce a spectacle lens. The computer-readable instructions to produce a spectacle lens may be
(j) stored on a computer-readable data carrier, or
(ii) transformed into a data carrier signal.

Typically, the computer-readable instructions to produce a spectacle lens comprise with respect to the lens substrate the selection of the optical material the lens substrate is based on.

Further typically, the computer-readable instructions to produce a spectacle lens with respect to the coating comprise at least one instruction selected from the group consisting of the coating sequence, the pressure in the chamber used for physical vapor deposition, the evaporation rate, the atmosphere in the chamber used for physical vapor deposition, the temperature, the distance of the material to be evaporated to the surface to be coated, the relative movement of the surface to be coated to the material to be evaporated; and optionally the application of an ion gun.

A first exemplary embodiment of the disclosure being directed to a method for manufacturing a spectacle lens comprising (i) an anti-reflective coating or (ii) a mirror coating. The (i) anti-reflective coating or the (ii) mirror coating consisting of a stack of a plurality of stack layers, the stack comprising an outermost stack layer, the outermost stack layer comprising silver (Ag). The method comprising the following step:
1) depositing the outermost stack layer by co-evaporating silver (Ag) and silicon-dioxide (SiO₂) in oxygen-ion-atmosphere, whereby proportions of the silver (Ag) and the silicon-dioxide (SiO₂) and the oxygen-ions are set that silver (Ag) clusters are formed in a SiO₂-matrix, whereby the silver (Ag) clusters having a maximum expansion within at least one of the following ranges
   (a) the silver (Ag) clusters having a maximum expansion of less than 20 nm
   (b) the silver (Ag) clusters having a maximum expansion of less than 15 nm
   (c) the silver (Ag) clusters having a maximum expansion of less than 10 nm
   (d) the silver (Ag) clusters having a maximum expansion in the range of 2 nm to 20 nm
   (e) the silver (Ag) clusters having a maximum expansion in the range of 2 nm to 15 nm
   (f) the silver (Ag) clusters having a maximum expansion in the range of 2 nm to 10 nm
   (g) the silver (Ag) clusters having a maximum expansion in the range of 5 nm to 20 nm
   (h) the silver (Ag) clusters having a maximum expansion in the range of 5 nm to 15 nm
   (i) the silver (Ag) clusters having a maximum expansion in the range of 5 nm to 10 nm.

The above described method may optionally be wherein during deposition of the composite layer comprising SiO₂ (matrix) and Ag an ion source is used e.g., with the following characteristics:

The type of ion source is an End-Hall type e.g., Mark II+ from Veeco, Planeview, N.Y. 11803, U.S.A. The ions are oxygen ions with an energy between 80 eV to 100 eV under vacuum conditions of typically between 2 to 6×10−4 mbar. Under these conditions, the ion current density at the substrate location is between 30 to 50 μA/cm². in that type of ion source the ion beam is neutralized by an emission of electrons. In addition to the oxygen ions leaving the ion source molecular oxygen is optionally added to the vacuum chamber.

A second exemplary embodiment of the disclosure being directed to a method for manufacturing a spectacle lens comprising (i) an anti-reflective coating or (ii) a mirror coating. The (i) anti-reflective coating or the (ii) mirror coating consisting of a stack of a plurality of stack layers, the stack comprising an outermost stack layer, at least the outermost stack layer comprising silver (Ag), the method comprising the following step:
1) depositing the outermost stack layer by co-evaporating silver (Ag), whereby a content of the silver (Ag) in at least the outermost stack layer is set to cause a photochromic effect, whereby the content of the silver (Ag) in at least the outermost stack layer is set such that a variation of a luminous transmittance (τ_{T0}) of the spectacle lens between a faded state according to 7.5.3.2 of ISO 8980-3: 2013(E) and a luminous transmittance (τ_{V1}) of the spectacle lens in a darkened state according to 7.5.3.3 of ISO 8980-3: 2013(E) caused by the photochromic effect is within a range of the following group:
   (A) τ_{V1}/τ_{V0}≤; 0.95,
(B) τ_{V1}/τ_{V0}≤0.98,
(C) 0.95≤τ_{V1}/τ_{V0}≤0.995,
(D) 0.98≤τ_{V1}/τ_{V0}≤0.995,
(E) 0.985≤τ_{V1}/T_{V0}≤0.995.

The above described method may optionally be characterized in the following additional step:
2) diffusing the silver (Ag) into stack layers other than the outermost stack layer.

A third exemplary embodiment of the disclosure being directed to a method for manufacturing a spectacle lens comprising a spectacle lens substrate and (i) an anti-reflective coating or (ii) a mirror coating. The (i) anti-reflective coating or the (ii) mirror coating consisting of a stack of a plurality of stack layers, the stack comprising an outermost stack layer, the outermost stack layer comprising silver (Ag), the outermost stack layer having an outer surface facing away from the spectacle lens surface, the method comprising the following step:
1) depositing the outermost stack layer such that the (i) anti-reflective coating or the (ii) mirror coating having a diffusivity (D_{F}) configured to ensure an absorption of water molecules passing through the (i) anti-reflective coating or the (ii) mirror coating into the spectacle lens substrate and a release of water molecules from the spectacle lens substrate through the (i) anti-reflective coating or the (ii) mirror coating from an air atmosphere arranged on the outer surface of the outermost stack layer; the air atmosphere having a moisture flow density (j_{D}); the diffusivity (D_{F}) being further configured to, starting from a first equilibrium state of the amount of water molecules absorbed in the spectacle lens substrate at an air atmosphere at 23 degrees centigrade and 50 percent relative humidity, effect a setting of a second equilibrium state of the amount of water molecules absorbed in the spectacle lens substrate at an air atmosphere at 40 degrees centigrade and 95 percent relative humidity within a first time interval; and, the first time interval being at most ten hours longer than a second time interval required for a setting of the second equilibrium state starting from the first equilibrium state in an uncoated spectacle lens substrate identical to the spectacle lens substrate.

A fourth exemplary embodiment of the disclosure being directed to a method for manufacturing a spectacle lens comprising a spectacle lens comprising (i) an anti-reflective coating or (ii) a mirror coating. The (i) anti-reflective coating or the (ii) mirror coating consisting of a stack of a plurality of stack layers, the stack comprising an outermost stack layer, at least the outermost stack layer comprising silver (Ag), the method comprising the following step:
1) depositing at least the outermost stack layer such that the silver (Ag) in at least the outermost stack layer having a content such that silver (Ag) ions from the spectacle lens are released upon exposing the spectacle lens to 10 ml of deionized water at 23 degrees centigrade for six hours a silver (Ag) providing an ion concentration of at least 0.1 mg/l being dissolved in the deionized water.

### BRIEF DESCRIPTION OF THE DRAWINGS

The disclosure will now be described with reference to the drawings wherein:

FIG. 1 shows a layer structure according to a first exemplary embodiment of a spectacle lens according to the disclosure; and

FIG. 2 shows a layer structure of a second exemplary embodiment of a spectacle lens according to the disclosure.

### DESCRIPTION OF EXEMPLARY EMBODIMENTS

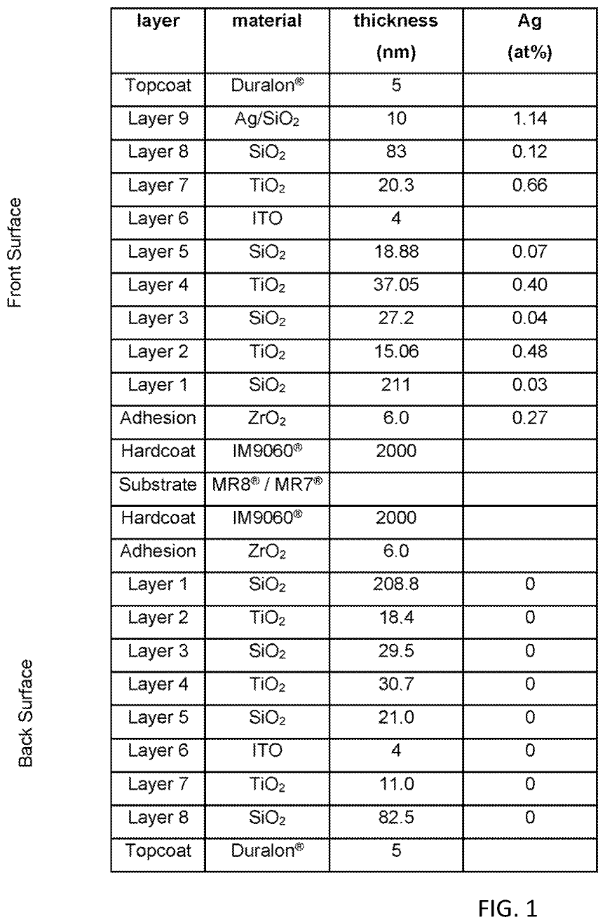

FIG. 1 shows a layer structure according to a first example of a spectacle lens according to the disclosure. The spectacle lens is based on a spectacle lens substrate which according to the example is made of an MR8® or MR7®-material being described in the general definition part of the description.

The front surface of the spectacle lens substrate is covered with a coating stack comprising starting from the substrate surface a hard coating, an adhesion promoting layer, an anti-reflection coating and a top coating. The hard coating comprising one layer being made of a material being sourced under the trade name IM9060® having a thickness of approx. 2000 nm. The adhesion promoting layer is ZrO₂ having a thickness of 6 nm. The anti-reflection coating comprises nine layers, indicated in FIG. 1 as “Layer 1” to “Layer 9.” Layers 1 to 5 are layers of SiO₂ and TiO₂ arranged in an alternate manner. Layer 6 is an indium tin oxide (ITO) layer serving as an anti-static layer. Layer 7 is a TiO₂ layer, while Layer 8 is SiO₂ substantially without Ag (0.12 at %), and Layer 9 is SiO₂ with a significant amount of Ag (1.14 at %). The top coating is a layer made of a material being known under the trade name Duralon®.

The back surface of the spectacle lens substrate is covered with a coating stack comprising starting from the substrate surface a hard coating, an adhesion promoting layer, an anti-reflection coating and a top coating. The hard coating comprising one layer being made of a material being sourced under the trade name IM9060® having a thickness of approx. 2000 nm. The adhesion promoting layer is ZrO₂ having a thickness of 6 nm. The anti-reflection coating comprises eight layers, indicated in FIG. 1 as “Layer 1” to “Layer 8.” Layers 1 to 5 are layers of SiO₂ and TiO₂ arranged in an alternate manner. Layer 6 is an indium tin oxide (ITO) layer serving as an anti-static layer. Layer 7 is a TiO₂ layer, while Layer 8 is SiO₂. The top coating is a layer made of a material being known under the trade name Duralon®.

The Hard coating is deposited by means of a wet chemical process. The other materials constituting the anti-reflective coating are deposited by means of physical vapor deposition processes. The top coating is deposited by means of thermal evaporation in vacuum.

In the context of the present disclosure it is relevant to note that in particular Layer 8 of both front and back side coating is deposited as follows:

SiO₂ is evaporated from an electron beam gun in the vacuum chamber. The power for the electron beam gun is selected in such a way that the deposition rate between 1 and 3 nm/s is reached. The pressure during deposition is between 1 and 4×10⁻⁴ mbar. Optionally, between 0 and 20 sccm (standard cubic centimeters per minute) molecular oxygen can be added to the vacuum chamber.

Layer 9 is deposited as follows:

Silver and silicon dioxide are co-deposited using two evaporation sources in the vacuum chamber simultaneously. These evaporation sources can be an electron beam gun for the SiO₂ and a thermal evaporator for the Ag. The power for these two evaporation sources is chosen in a way that the appropriate silver content in the matrix is reached. This is done via a calibration process during which the sources are operated alone and respective film thicknesses are measured. From the film thicknesses of both films the appropriate power ratio is calculated.

During co-deposition of the composite layer comprising SiO₂ (matrix) and Ag an ion source is used e.g., with the following characteristics:

The type of ion source is an End-Hall type e.g., Mark II+ from Veeco, Planeview, N.Y. 11803, U.S.A. The ions are oxygen ions with an energy between 80 eV to 100 eV under vacuum conditions of typically between 2 to 6×10⁴ mbar. Under these conditions the ion current density at the substrate location is between 30 to 50 μA/cm². in that type of ion source the ion beam is neutralized by an emission of electrons. In addition to the oxygen ions leaving the ion source molecular oxygen is optionally added to the vacuum chamber.

During and subsequent to the deposition of silver, the silver is urged to diffuse into layers underneath the outermost stack layer, which is Layer 9, of the anti-reflection coating. Therefore, silver is not only located in the outermost stack layer forming the anti-reflection coating but also in other layers of the anti-reflection coating. The respective amounts of silver are indicated in the righthand side column of FIG. 1.

The deposition parameters are adjusted such that a photochromic effect is caused by the silver, whereby the content of the silver (Ag) in at least the outermost stack layer is set such that a variation of a luminous transmittance (τ_{T0}) of the spectacle lens between a faded state according to 7.5.3.2 of ISO 8980-3: 2013(E) and a luminous transmittance (τ_{V1}) of the spectacle lens in a darkened state according to 7.5.3.3 of ISO 8980-3: 2013(E) caused by the photochromic effect is within a range of 0.95≤τ_{V1}/τ_{V0}≤0.995.

The deposition parameters in addition are adjusted such that silver clusters are formed in the outermost stack layer 9 having a maximum expansion in the range of 5 nm to 10 nm.

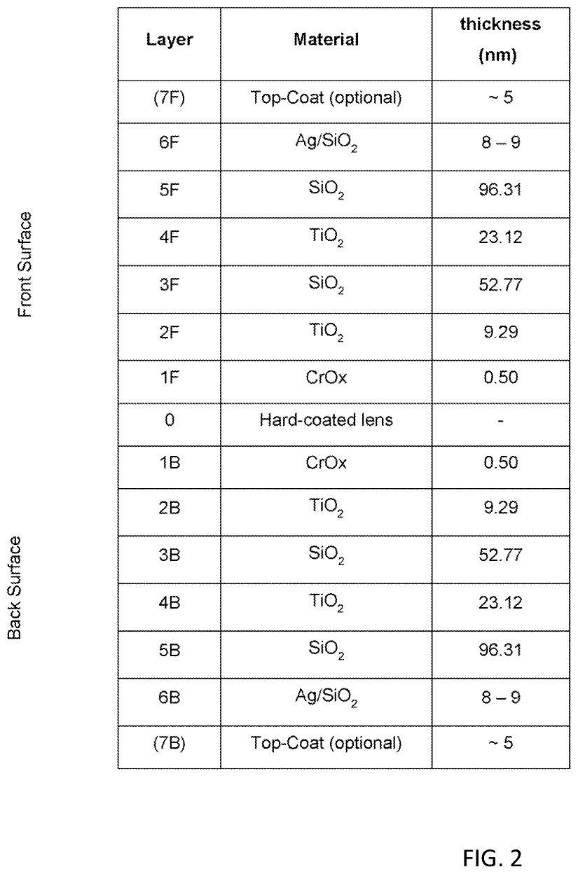

FIG. 2 shows a layer structure according to a second example of a spectacle lens according to the disclosure. The spectacle lens is based on a spectacle lens substrate which according to the example may be made of polycarbonate being described as a suitable spectacle lens material in the general definition part of the description.

Both, the front surface and the back surface of the spectacle lens substrate are covered with an identical coating. The coating consisting of a coating stack comprising starting from the substrate surface a primer coating (such as one being sold under the trade name P12), a hard coating, an adhesion promoting layer, an anti-reflection coating and an optional top coating. The hard coating comprises one layer being made of a material being sourced under the trade name F08® having a thickness of approx. 2000 nm. The adhesion promoting layer is CrOₓ having a thickness of 0.5 nm. The anti-reflection coating comprises five layers, indicated in FIG. 2 as “2F/2B” to “6F/6B.” Layers 2F/2B to 5F/5B are layers of TiO₂ and SiO₂ arranged in an alternate manner. Layer 6F/6B is SiO₂ with a significant amount of Ag. The top coating is a layer, which may be made of a material being known under the trade name Duralon®.

The Hard coating is deposited by means of a wet chemical process. The other materials constituting the anti-reflective coating are deposited by means of physical vapor deposition processes. The top coating is deposited by means of thermal evaporation in vacuum.

In the context of the present disclosure it is relevant to note that in particular layer 5F/5B is deposited as follows:

SiO₂ is evaporated from an electron beam gun in the vacuum chamber. The power for the electron beam gun is selected in such a way that the deposition rate between 1 and 3 nm/s is reached. The pressure during deposition is between 1 and 4×10⁻⁴ mbar. Optionally, between 0 and 20 sccm molecular oxygen can be added to the vacuum chamber.

Layer 6F/6B is deposited as follows:

Silver and silicon dioxide are co-deposited using two evaporation sources in the vacuum chamber simultaneously. These evaporation sources can be an electron beam gun for the SiO₂ and a thermal evaporator for the Ag. The power for these two evaporation sources is chosen in a way that the appropriate silver content in the matrix is reached. This is done via a calibration process during which the sources are operated alone and respective film thicknesses are measured. From the film thicknesses of both films the appropriate power ratio is calculated.

During co-deposition of the composite layer comprising SiO₂ (matrix) and Ag an ion source is used e.g., with the following characteristics:

The type of ion source is an End-Hall type e.g., Mark II+ from Veeco, Planeview, N.Y. 11803, U.S.A. The ions are oxygen ions with an energy between 80 eV to 100 eV under vacuum conditions of typically between 2 to 6×10⁴ mbar. Under these conditions the ion current density at the substrate location is between 30 to 50 μA/cm². in that type of ion source the ion beam is neutralized by an emission of electrons. In addition to the oxygen ions leaving the ion source molecular oxygen is optionally added to the vacuum chamber.

During and subsequent to the deposition of silver, the silver is urged to diffuse into layers underneath the outermost stack layer of the anti-reflection coating. Therefore, silver is not only located in the outermost stack layer forming the anti-reflection coating but also in other layers of the anti-reflection coating.

The deposition parameters are adjusted such that the anti-reflective coating has a diffusivity (D_{F}) configured to ensure an absorption of water molecules passing through the anti-reflective coating into the spectacle lens substrate and a release of water molecules from the spectacle lens substrate through the anti-reflective coating from an air atmosphere arranged on the outer surface of the outermost stack layer. The air atmosphere having a moisture flow density (j_{D}); the diffusivity (D_{F}) being further configured to, starting from a first equilibrium state of the amount of water molecules absorbed in the spectacle lens substrate at an air atmosphere at 23 degrees centigrade and 50 percent relative humidity, effect a setting of a second equilibrium state of the amount of water molecules absorbed in the spectacle lens substrate at an air atmosphere at 40 degrees centigrade and 95 percent relative humidity within a first time interval; and, the first time interval being at most ten hours longer than a second time interval required for a setting of the second equilibrium state starting from the first equilibrium state in an uncoated spectacle lens substrate identical to the spectacle lens substrate. The respective guideline to adjust deposition parameters are outlined in U.S. Pat. No. 9,778,484 B2.

The deposition parameters in addition are adjusted such that silver clusters are formed in the outermost stack layer 6F/6B have a maximum expansion in the range of 5 nm to 15 nm.

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

1. A spectacle lens comprising:
(i) an anti-reflective coating reducing light reflected from a surface of the anti-reflective coating such that a value for a light reflection factor pV as determined and defined according to Sec. 4.2 of EN ISO 8980-4:2006 is less than 2.5%; or
(ii) a mirror coating,
the anti-reflective coating or the mirror coating including a stack of a plurality of stack layers, the stack having an outermost stack layer, the outermost stack layer containing a plurality of separated silver (Ag) atoms and/or a plurality of silver (Ag) clusters in a SiO₂-matrix, each of the silver (Ag) clusters having a maximum expansion within at least one of the following ranges:
(a) each silver (Ag) cluster having the maximum expansion of less than 20 nm,
(b) each silver (Ag) cluster having the maximum expansion of less than 15 nm,
(c) each silver (Ag) cluster having the maximum expansion of less than 10 nm,
(d) each silver (Ag) cluster having the maximum expansion in the range of 2 nm to 20 nm,
(e) each silver (Ag) cluster having the maximum expansion in the range of 2 nm to 15 nm,
(f) each silver (Ag) cluster having the maximum expansion in the range of 2 nm to 10 nm,
(g) each silver (Ag) cluster having the maximum expansion in the range of 5 nm to 20 nm,
(h) each silver (Ag) cluster having the maximum expansion in the range of 5 nm to 15 nm, or
(i) each silver (Ag) cluster having the maximum expansion in the range of 5 nm to 10 nm.

2. A spectacle lens comprising:
(i) an anti-reflective coating; or
(ii) a mirror coating,
the anti-reflective coating or the mirror coating including a stack of a plurality of stack layers, the stack having an outermost stack layer, the outermost stack layer containing a plurality of separated silver (Ag) atoms and/or a plurality of silver (Ag) clusters in a SiO₂-matrix, each of the silver (Ag) clusters having a maximum expansion within at least one of the following ranges:
(a) each silver (Ag) cluster having the maximum expansion of less than 20 nm,
(b) each silver (Ag) cluster having the maximum expansion of less than 15 nm,
(c) each silver (Ag) cluster having the maximum expansion of less than 10 nm,
(d) each silver (Ag) cluster having the maximum expansion in the range of 2 nm to 20 nm,
(e) each silver (Ag) cluster having the maximum expansion in the range of 2 nm to 15 nm,
(f) each silver (Ag) cluster having the maximum expansion in the range of 2 nm to 10 nm,
(g) each silver (Ag) cluster having the maximum expansion in the range of 5 nm to 20 nm,
(h) each silver (Ag) cluster having the maximum expansion in the range of 5 nm to 15 nm, or
(i) each silver (Ag) cluster having the maximum expansion in the range of 5 nm to 10 nm,
and at least one of the stack layers in addition to the outermost stack layer contains the silver (Ag).

3. The spectacle lens according to claim 1, wherein a substance proportion of the silver (Ag) in the SiO₂-matrix is within at least one of the following ranges:
a. the substance proportion of the silver (Ag) in the SiO₂-matrix being less than 1.5 at %,
b. the substance proportion of the silver (Ag) in the SiO₂-matrix being less than 1.3 at %,
c. the substance proportion of the silver (Ag) in the SiO₂-matrix being less than 1.2 at %,
d. the substance proportion of the silver (Ag) in the SiO₂-matrix being in the range between 0.8 at % and 1.5 at %,
e. the substance proportion of the silver (Ag) in the SiO₂-matrix being in the range between 0.9 at % and 1.3 at %,
f. the substance proportion of the silver (Ag) in the SiO₂-matrix being in the range between 1.0 at % and 1.2 at %, or
g. the substance proportion of the silver (Ag) in the SiO₂-matrix being in the range between 1.05 at % and 1.15 at %.

4. A spectacle lens comprising:
(i) an anti-reflective coating reducing light reflected from a surface of the anti-reflective coating such that a value for a light reflection factor pV as determined and defined according to Sec. 4.2 of EN ISO 8980-4:2006 is less than 2.5%; or
(ii) a mirror coating,
the anti-reflective coating or the mirror coating including a stack of a plurality of stack layers, the plurality of stack layers having an outermost stack layer, the outermost stack layer containing silver (Ag) in a SiO₂-matrix, wherein a substance proportion of the silver (Ag) in the SiO₂-matrix is within at least one of the following ranges:
a. the substance proportion of the silver (Ag) in the SiO₂-matrix being less than 1.5 at %,
b. the substance proportion of the silver (Ag) in the SiO₂-matrix being less than 1.3 at %,
c. the substance proportion of the silver (Ag) in the SiO₂-matrix being less than 1.2 at %,
d. the substance proportion of the silver (Ag) in the SiO₂-matrix being in the range between 0.8 at % and 1.5 at %,
e. the substance proportion of the silver (Ag) in the SiO₂-matrix being in the range between 0.9 at % and 1.3 at %,
f. the substance proportion of the silver (Ag) in the SiO₂-matrix being in the range between 1.0 at % and 1.2 at %, or
g. the substance proportion of the silver (Ag) in the SiO₂-matrix being in the range between 1.05 at % and 1.15 at %.

5. A spectacle lens comprising:
(i) an anti-reflective coating; or
(ii) a mirror coating,
the anti-reflective coating or the mirror coating including a stack of a plurality of stack layers, the stack having an outermost stack layer, the outermost stack layer containing silver (Ag) in a SiO₂-matrix, wherein a substance proportion of the silver (Ag) in the SiO₂-matrix is within at least one of the following ranges:
a. the substance proportion of the silver (Ag) in the SiO₂-matrix being less than 1.5 at %,
b. the substance proportion of the silver (Ag) in the SiO₂-matrix being less than 1.3 at %,
c. the substance proportion of the silver (Ag) in the SiO₂-matrix being less than 1.2 at %,
d. the substance proportion of the silver (Ag) in the SiO₂-matrix being in the range between 0.8 at % and 1.5 at %,
e. the substance proportion of the silver (Ag) in the SiO₂-matrix being in the range between 0.9 at % and 1.3 at %,
f. the substance proportion of the silver (Ag) in the SiO₂-matrix being in the range between 1.0 at % and 1.2 at %, or
g. the substance proportion of the silver (Ag) in the SiO₂-matrix being in the range between 1.05 at % and 1.15 at %,
and at least one of the stack layers in addition to the outermost stack layer contains the silver (Ag).

6. The spectacle lens according to claim 1, wherein any coating or layer not contributing to an antireflective property of the spectacle lens is not part of the anti-reflective coating.

7. The spectacle lens according to claim 1, wherein the anti-reflective coating is a transparent thin film structure with alternating layers of contrasting refractive indices, and wherein layer thicknesses are chosen to produce destructive interference in light beams reflected from an interface, and constructive interference in corresponding transmitted light beams.

8. A spectacle lens comprising:
(i) an anti-reflective coating; or
(ii) a mirror coating,
the anti-reflective coating or the mirror coating including a stack of a plurality of stack layers, the stack having an outermost stack layer, at least the outermost stack layer containing silver (Ag), wherein the silver (Ag) in at least the outermost stack layer has a content causing a photochromic effect, wherein the content of the silver (Ag) in at least the outermost stack layer is set such that a variation of a luminous transmittance (τ_{T0}) of the spectacle lens between a faded state according to 7.5.3.2 of ISO 8980-3:2013(E) and a luminous transmittance (τ_{V1}) of the spectacle lens in a darkened state according to 7.5.3.3 of ISO 8980-3:2013(E) caused by the photochromic effect is within at least one of the following ranges:
(A) τ_{V1}/τ_{V0} 0.95,
(B) τ_{V1}/τ_{V0}≤0.98,
(C) 0.95≤τ_{V1}/τ_{V0}≤0.995,
(D) 0.98≤τ_{V1}/τ_{V0}≤0.995, or
(E) 0.985≤τ_{V1}/τ_{V0}≤0.995.

9. A spectacle lens comprising:
a spectacle lens substrate; and
(i) an anti-reflective coating or (ii) a mirror coating,
the anti-reflective coating or the mirror coating including a stack of a plurality of stack layers, the stack having an outermost stack layer, the outermost stack layer containing silver (Ag) and having an outer surface facing away from a spectacle lens substrate surface, wherein the anti-reflective coating or the mirror coating has a diffusivity (D_{F}) configured to ensure an absorption of water molecules passing from an air atmosphere arranged on the outer surface of the outermost stack layer through the anti-reflective coating or the mirror coating into the spectacle lens substrate and a release of the water molecules from the spectacle lens substrate through the anti-reflective coating or the mirror coating into the air atmosphere, the diffusivity (D_{F}) being further configured to, starting from a first equilibrium state of an amount of the water molecules absorbed in the spectacle lens substrate at the air atmosphere at 23 degrees centigrade and 50 percent relative humidity, effect a setting of a second equilibrium state of the amount of the water molecules absorbed in the spectacle lens substrate at the air atmosphere at 40 degrees centigrade and 95 percent relative humidity within a first time interval, and, the first time interval being at most ten hours longer than a second time interval required for the setting of a second equilibrium state starting from the first equilibrium state in an uncoated spectacle lens substrate identical to the spectacle lens substrate.

10. A spectacle lens comprising:
(i) an anti-reflective coating; or
(ii) a mirror coating,
the anti-reflective coating or the mirror coating having a stack of a plurality of stack layers, the stack having an outermost stack layer, at least the outermost stack layer containing silver (Ag), wherein the silver (Ag) in at least the outermost stack layer has a content such that upon releasing silver (Ag) ions from the spectacle lens by exposing the spectacle lens to 10 ml of deionized water at 23 degrees centigrade for six hours, a silver (Ag) ion concentration of the silver (Ag) dissolved in the deionized water is at least 0.1 mg/l.

11. The spectacle lens according to claim 8, wherein the outermost stack layer comprises a SiO₂-matrix containing the silver (Ag).

12. The spectacle lens according to claim 11, wherein at least a part of the silver (Ag) in the SiO₂-matrix forms silver (Ag) clusters, wherein the silver (Ag) clusters have a maximum expansion within at least one of the following ranges:
(a) the silver (Ag) clusters having the maximum expansion of less than 20 nm,
(b) the silver (Ag) clusters having the maximum expansion of less than 15 nm,
(c) the silver (Ag) clusters having the maximum expansion of less than 10 nm,
(d) the silver (Ag) clusters having the maximum expansion in the range of 2 nm to 20 nm,
(e) the silver (Ag) clusters having the maximum expansion in the range of 2 nm to 15 nm,
(f) the silver (Ag) clusters having the maximum expansion in the range of 2 nm to 10 nm,
(g) the silver (Ag) clusters having the maximum expansion in the range of 5 nm to 20 nm,
(h) the silver (Ag) clusters having the maximum expansion in the range of 5 nm to 15 nm, or
(i) the silver (Ag) clusters having the maximum expansion in the range of 5 nm to 10 nm.

13. The spectacle lens according to claim 11, wherein at least a part of the silver (Ag) in the SiO₂-matrix are silver (Ag) atoms being interstitially arranged in the SiO₂-matrix.

14. The spectacle lens according to claim 1, wherein the outermost stack layer has a thickness within at least one of the following ranges:
i. the outermost stack layer having a thickness in a range of 5 nm to 50 nm,
ii. the outermost stack layer having a thickness in a range of 5 nm to 40 nm,
iii. the outermost stack layer having a thickness in a range of 5 nm to 30 nm,
iv. the outermost stack layer having a thickness in a range of 5 nm to 20 nm, or
v. the outermost stack layer having a thickness in a range of 5 nm to 15 nm.

15. The spectacle lens according to claim 1, wherein at least one of the stack layers in addition to the outermost stack layer also contains the silver (Ag).

16. The spectacle lens according to claim 15, wherein at least a part of the silver (Ag) in the at least one of the stack layers in addition to the outermost stack layer forms silver (Ag) clusters, wherein the silver (Ag) clusters in the at least one of the stack layers in addition to the outermost stack layer have a maximum expansion within at least one of the following ranges:
(a) the silver (Ag) clusters having the maximum expansion of less than 20 nm,
(b) the silver (Ag) clusters having the maximum expansion of less than 15 nm,
(c) the silver (Ag) clusters having the maximum expansion of less than 10 nm,
(d) the silver (Ag) clusters having the maximum expansion in the range of 2 nm to 20 nm,
(e) the silver (Ag) clusters having the maximum expansion in the range of 2 nm to 15 nm,
(f) the silver (Ag) clusters having the maximum expansion in the range of 2 nm to 10 nm,
(g) the silver (Ag) clusters having the maximum expansion in the range of 5 nm to 20 nm,
(h) the silver (Ag) clusters having the maximum expansion in the range of 5 nm to 15 nm, or
(i) the silver (Ag) clusters having the maximum expansion in the range of 5 nm to 10 nm.

17. The spectacle lens according to claim 15, wherein at least one of the at least one of the stack layers in addition to the outermost stack layer containing the silver (Ag) is a TiO₂-matrix containing the silver (Ag).

18. The spectacle lens according to claim 17, wherein a substance proportion of the silver (Ag) in the TiO₂-matrix is within at least one of the following ranges:
a) the substance proportion of the silver (Ag) in the TiO₂-matrix being less than 0.9 at %,
b) the substance proportion of the silver (Ag) in the TiO₂-matrix being less than 0.8 at %,
c) the substance proportion of the silver (Ag) in the TiO₂-matrix being less than 0.7 at %,
d) the substance proportion of the silver (Ag) in the TiO₂-matrix being in the range between 0.2 at % and 0.9 at %,
e) the substance proportion of the silver (Ag) in the TiO₂-matrix being in the range between 0.25 at % and 0.8 at %,
f) the substance proportion of the silver (Ag) in the TiO₂-matrix being in the range between 0.3 at % and 0.75 at %, or
g) the substance proportion of the silver (Ag) in the TiO₂-matrix being in the range between 0.35 at % and 0.7 at %.

19. The spectacle lens according to claim 15, wherein at least one of the stack layers in addition to the outermost stack layer containing the silver (Ag) is a SiO₂-layer.

20. The spectacle lens according to claim 19, wherein a substance proportion of the silver (Ag) in the SiO₂-matrix of the at least one of the stack layers in addition to the outermost stack layer being within at least one of the following ranges:
a) the substance proportion of the silver (Ag) in the SiO₂-matrix being less than 0.25 at %,
b) the substance proportion of the silver (Ag) in the SiO₂-matrix being less than 0.2 at %,
c) the substance proportion of the silver (Ag) in the SiO₂-matrix being less than 0.15 at %,
d) the substance proportion of the silver (Ag) in the SiO₂-matrix being in the range between 0.01 at % and 0.25 at %,
e) the substance proportion of the silver (Ag) in the SiO₂-matrix being in the range between 0.01 at % and 0.2 at %, or
f) the substance proportion of the silver (Ag) in the SiO₂-matrix being in the range between 0.01 at % and 0.15 at %.

21. The spectacle lens according to claim 20, wherein a substance proportion of the silver (Ag) in the SiO₂-matrix of a first stack layer is lower than a substance proportion of the silver (Ag) in a TiO₂-matrix of a second stack layer adjacent to the first stack layer.

22. The spectacle lens according to claim 1, wherein a content of the silver (Ag) in the spectacle lens is set to kill 99.9% of enveloped viruses as measured according to ISO 21702:2019.

23. The spectacle lens according to claim 1, wherein a content of the silver (Ag) in the spectacle lens is set to kill 99.9% of bacteria as measured according to ISO 22196:2011.

24. The spectacle lens according to claim 1, wherein a luminance transmittance in a faded state as defined in 7.5.3.2 of ISO 8980-3:2013(E) exceeds at least one value of the following group:
(1) the value of the luminance transmittance exceeds 95%,
(2) the value of the luminance transmittance exceeds 96%, or
(3) the value of the luminance transmittance exceeds 97%.

25. A method for manufacturing a spectacle lens having (i) an anti-reflective coating, the anti-reflective coating reducing light reflected from a surface of the anti-reflective coating such that a value for the light reflection factor pV as determined and defined according to Sec. 4.2 of EN ISO 8980-4:2006 is less than 2.5%, or (ii) a mirror coating, the anti-reflective coating or the mirror coating including a stack of a plurality of stack layers, the stack having an outermost stack layer containing silver (Ag), the method comprising:
depositing the outermost stack layer by co-evaporating the silver (Ag) and silicon-dioxide (SiO₂) in an oxygen-ion-atmosphere, wherein proportions of the silver (Ag) and the silicon-dioxide (SiO₂) and the oxygen-ions are set so that silver (Ag) clusters are formed in a SiO₂-matrix, wherein the silver (Ag) clusters have a maximum expansion within at least one of the following ranges:
(a) the silver (Ag) clusters having the maximum expansion of less than 20 nm,
(b) the silver (Ag) clusters having the maximum expansion of less than 15 nm,
(c) the silver (Ag) clusters having the maximum expansion of less than 10 nm,
(d) the silver (Ag) clusters having the maximum expansion in the range of 2 nm to 20 nm,
(e) the silver (Ag) clusters having the maximum expansion in the range of 2 nm to 15 nm,
(f) the silver (Ag) clusters having the maximum expansion in the range of 2 nm to 10 nm,
(g) the silver (Ag) clusters having the maximum expansion in the range of 5 nm to 20 nm,
(h) the silver (Ag) clusters having the maximum expansion in the range of 5 nm to 15 nm, or
(i) the silver (Ag) clusters having the maximum expansion in the range of 5 nm to 10 nm.

26. The method according to claim 25, wherein the silver (Ag) and the silicon-dioxide (SiO₂) are co-deposited using two evaporation sources in a vacuum chamber simultaneously, wherein the two evaporation sources are an electron beam gun for the silicon-dioxide (SiO₂) and a thermal evaporator for the silver (Ag).

27. A method for manufacturing a spectacle lens comprising (i) an anti-reflective coating or (ii) a mirror coating, the anti-reflective coating or the mirror coating including a stack of a plurality of stack layers, the stack having an outermost stack layer, at least the outermost stack layer containing silver (Ag), the method comprising:
depositing the outermost stack layer by co-evaporating silver (Ag), wherein a content of the silver (Ag) in at least the outermost stack layer is set to cause a photochromic effect, wherein the content of the silver (Ag) in at least the outermost stack layer is set such that a variation of a luminous transmittance (τ_{T0}) of the spectacle lens between a faded state according to 7.5.3.2 of ISO 8980-3: 2013(E) and a luminous transmittance (τ_{V1}) of the spectacle lens in a darkened state according to 7.5.3.3 of ISO 8980-3: 2013(E) caused by the photochromic effect is within at least one of the following ranges:
(A) τ_{V1}/τ_{V0}≤0.95,
(B) τ_{V1}/τ_{V0}≤0.98,
(C) 0.95≤τ_{V1}/τ_{V0}≤0.995,
(D) 0.98≤τ_{V1}/τ_{V0}≤0.995, or
(E) 0.985≤τ_{V1}/T_{V0}≤0.995.

28. The method according to claim 25, further comprising:
diffusing the silver (Ag) into stack layers other than the outermost stack layer.

29. A method for manufacturing a spectacle lens comprising (i) an anti-reflective coating or (ii) a mirror coating, the anti-reflective coating or the mirror coating including a stack of a plurality of stack layers, the stack having an outermost stack layer, at least the outermost stack layer comprising silver (Ag), the method comprising:
depositing the outermost stack layer by co-evaporating silver (Ag), wherein a content of the silver (Ag) in at least the outermost stack layer is set to cause a photochromic effect, wherein the content of the silver (Ag) in at least the outermost stack layer is set such that a variation of a luminous transmittance (τ_{T0}) of the spectacle lens between a faded state according to 7.5.3.2 of ISO 8980-3: 2013(E) and a luminous transmittance (τ_{V1}) of the spectacle lens in a darkened state according to 7.5.3.3 of ISO 8980-3: 2013(E) caused by the photochromic effect is within at least one of the following ranges:
(A) τ_{V1}/τ_{V0}≤0.95,
(B) τ_{V1}/τ_{V0}≤0.98,
(C) 0.95≤τ_{V1}/τ_{V0}≤0.995,
(D) 0.98≤τ_{V1}/τ_{V0}≤0.995, or
(E) 0.985≤τ_{V1}/τ_{T0}≤0.995; and
diffusing the silver (Ag) into stack layers other than the outermost stack layer.

30. A method for manufacturing a spectacle lens comprising a spectacle lens substrate and (i) an anti-reflective coating or (ii) a mirror coating, the anti-reflective coating or the mirror coating including a stack of a plurality of stack layers, the stack having an outermost stack layer, the outermost stack layer containing silver (Ag) and having an outer surface facing away from a spectacle lens substrate surface, the method comprising:
depositing the outermost stack layer such that the anti-reflective coating or the mirror coating have a diffusivity (D_{F}) configured to ensure an absorption of water molecules passing from an air atmosphere arranged on the outer surface of the outermost stack layer through the anti-reflective coating or the mirror coating into the spectacle lens substrate and a release of the water molecules from the spectacle lens substrate through the anti-reflective coating or the mirror coating into the air atmosphere, the air atmosphere having a moisture flow density (j_{D}), the diffusivity (D_{F}) being further configured to, starting from a first equilibrium state of an amount of water molecules absorbed in the spectacle lens substrate at the air atmosphere at 23 degrees centigrade and 50 percent relative humidity, effect a setting of a second equilibrium state of the amount of water molecules absorbed in the spectacle lens substrate at the air atmosphere at 40 degrees centigrade and 95 percent relative humidity within a first time interval, and, the first time interval being at most ten hours longer than a second time interval required for the setting of the second equilibrium state starting from the first equilibrium state in an uncoated spectacle lens substrate identical to the spectacle lens substrate.

31. A method for manufacturing a spectacle lens having a spectacle lens substrate and (i) an anti-reflective coating or (ii) a mirror coating, the anti-reflective coating or the mirror coating including a stack of a plurality of stack layers, the stack having an outermost stack layer, the outermost stack layer containing silver (Ag) and having an outer surface facing away from a spectacle lens substrate surface, the method comprising:
depositing the outermost stack layer such that the anti-reflective coating or the mirror coating has a diffusivity (D_{F}) configured to ensure an absorption of water molecules passing from an air atmosphere arranged on the outer surface of the outermost stack layer through the anti-reflective coating or the mirror coating into the spectacle lens substrate and a release of the water molecules from the spectacle lens substrate through the anti-reflective coating or the mirror coating into the air atmosphere, the air atmosphere having a moisture flow density (j_{D}), the diffusivity (D_{F}) being further configured to, starting from a first equilibrium state of an amount of water molecules absorbed in the spectacle lens substrate at the air atmosphere at 23 degrees centigrade and 50 percent relative humidity, effect a setting of a second equilibrium state of the amount of water molecules absorbed in the spectacle lens substrate at the air atmosphere at 40 degrees centigrade and 95 percent relative humidity within a first time interval, and, the first time interval being at most ten hours longer than a second time interval required for the setting of the second equilibrium state starting from the first equilibrium state in an uncoated spectacle lens substrate identical to the spectacle lens substrate; and
promoting the silver to diffuse into layers underneath the outermost stack layer of the anti-reflection coating during and subsequent to a deposition of silver.

32. The method according to claim 31, further comprising:
depositing of the outermost stack layer by co-depositing.

33. A method for manufacturing a spectacle lens, the spectacle lens having (i) an anti-reflective coating or (ii) a mirror coating, the anti-reflective coating or the mirror coating including a stack of a plurality of stack layers, the stack having an outermost stack layer, at least the outermost stack layer containing silver (Ag), the method comprising:
depositing at least the outermost stack layer such that the silver (Ag) in at least the outermost stack layer has a content such that silver (Ag) ions from the spectacle lens are released upon exposing the spectacle lens to 10 ml of deionized water at 23 degrees centigrade for six hours provides a silver (Ag) ion concentration dissolved in the deionized water of at least 0.1 mg/l.

34. A computer-readable non-transitory data storage carrier comprising a spectacle lens in the form of computer-readable instructions for the production of the spectacle lens according to claim 1.

35. A computer program stored on a non-transitory data storage carrier comprising a spectacle lens in the form of computer-readable instructions for the production of the spectacle lens according to claim 1.
